(19) United States
(12) Patent Application Publication
(10) Pub. No.: US 2024/0158992 A1
(43) Pub. Date: May 16, 2024

(54) PULP-MOLDING MOULD ASSEMBLY WITH HEATING DEVICE

(71) Applicant: Golden Arrow Printing Technology (Kunshan) Co., LTD., Kunshan City (CN)

(72) Inventors: CHIEN-KUAN KUO, New Taipei City (TW); CHUN-HUANG HUANG, New Taipei City (TW)

(21) Appl. No.: 18/491,788

(22) Filed: Oct. 22, 2023

(30) Foreign Application Priority Data
Nov. 10, 2022 (CN) 202222990688.5

(51) Int. Cl. D21J 3/10

(52) U.S. Cl. CPC D21J 3/10

(57) ABSTRACT

A pulp-molding mould assembly with a heating device is configured for integrally forming paper-made articles, and comprises: at least one mould and a number of heating tubes. The at least one mould has a main accommodating chamber which is defined with a main three-dimensional inner circumferential surface and a main inner space. The heating tubes are layer-by-layer arranged into multilayer-stacked structure in an evenly and annularly heating distribution around the main three-dimensional inner circumferential surface. This could not only make the heating tubes evenly heating against the main three-dimensional inner circumferential surface and reduce heat-conducting distances from the heating tubes to the respective paper-made article, for reducing a power consumption thereof, but also make the heating tubes evenly heating an air inside the main inner space for making the main accommodating chamber yields a thermal preservation effect by way of a vacuum heat-insulation thereof.

### FIELD OF THE INVENTION

The present invention relates to a technical field about a wet-type pulp-molding mould assembly and its heating device, and more particularly, to a pulp-molding mould assembly with a heating device.

### BACKGROUND OF THE INVENTION

Most of traditional container or packaging adopts a disposable plastic-made article which is usable to be processed by a biodegradable or bio-compostable process for the nature environment. During the usages of massive plastic-made articles for a long time, it is apt to invoke severe harms for the environmental protection, and to also invoke the matters or diseases for the human body's health.

Against the quantity of those plastic-made articles being used in gradually increasing, there were a wet-type pulp-molding technique and its automatic production line introduced currently for producing the containers or packaging from a biodegradable or bio-compostable material (e.g., plant fibers). In these traditional wet-type pulp-molding automatic production line, regardless of whether a suction forming stage is applied to thermally compress a rough body, containing the plant fibers with a higher humidity, so as to form a semi-finished article with a lower humidity, or a thermal compression shaping stage is applied to thermally compress the semi-finished article with a lower humidity so as to shape a finished product shape, the plant-fiber rough body, the semi-finished article or the finished product all can be so-called herein a “paper-made article”. For having a higher dryness, the respective paper-made articles all need to be die-matched by between two paired upper and lower moulds (namely two male and female moulds) in a pulp-molding mould assembly. At the same time when the paired moulds are die-matched to compress the paper-made article, heating devices deployed within the paired moulds also heat the paper-made article in a high temperature so as to expeditiously remove vapor or moisture out of the paper-made article. In regard to a variety of structural designs of the traditional pulp-molding mould assembly having the heating devices, please refer to the disclosures of Chinese Utility model/invention patent issue numbers or patent application publication numbers CN201785677U, CN201121287Y, CN110512470A, CN108265568A, CN103966926A, CN102700175A, CN202210258717.0, and so forth.

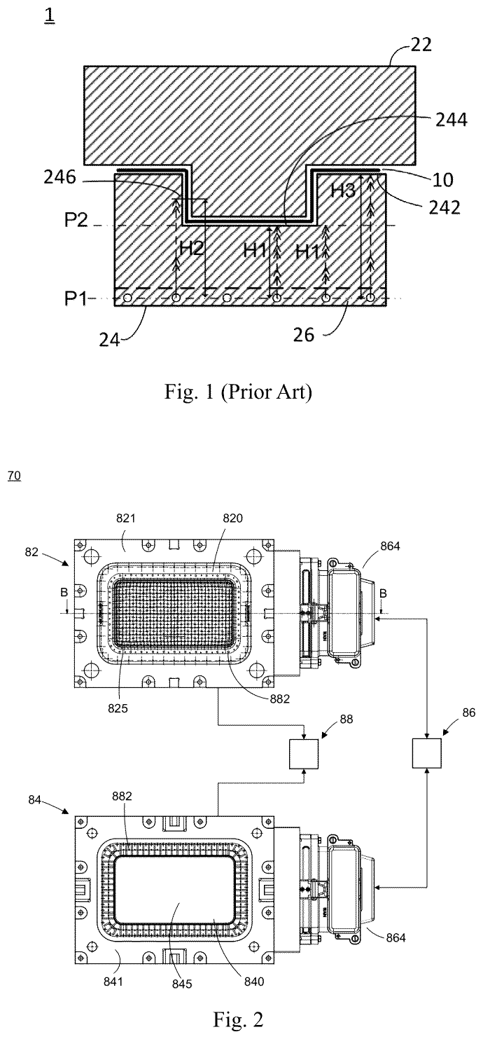

Since common pulp-molded paper article is mostly formed with three-dimensional contour dimensions in its overall shape, the inner/outer shapes and dimensions of pulp-molding moulds applied for producing the paper-made article are also necessarily consistent with the three-dimensional contour dimensions of the paper-made article. However, in a case depicted in FIG. 1, a traditional pulp-molding mould assembly 1 having heating devices 26 is introduced with a number of schematically heating routes thereof. The traditional pulp-molding mould assembly 1 (comprising two die-matched male and female moulds 22, 24) frequently incurs the following technical matters that: for a heating distribution, the traditional heating devices 26 (e.g., a heating pipeline or a heating plate) all are mostly arranged along a two-dimensional plane P1 which is located in the same height from the back portion to the inside of the traditional pulp-molding moulds 24 (e.g., a female mould); briefly, the heating distribution of the traditional heating devices 26 (e.g., the heating tubes or the heating plate) located on the two-dimensional plane P1 in the same height merely provide the same specific datum plane P2, inside the traditional pulp-molding moulds 24 (e.g., the female mould), with the same heating conditions. For example, the same heat-conducting (or thermal diffusion) distances H1 and the same heat-conducting velocities. However, by such a heating distribution of the traditional heating devices 26 (e.g., the heating tubes or the heating plate) being located on the same-height two-dimensional plane P1, it is extremely inadequate for heating a forming surface of the traditional pulp-molding mould 24 (namely a mould surface used for directly forming the three-dimensional contour dimensions of the corresponding paper-made article 10), a three-dimensional contour shape of which has more different level differences (as labeled in numerals 242, 244 and 246 in the diagram). For example, some heat-conducting (or thermal diffusion) distances H3 for correspondingly heating a higher-located forming surface 242 farther away from the heating devices 26 are too long, and their relevant heat-conducting velocities for the higher-located forming surface 242 are too slow; on the contrary, some other heat-conducting (or thermal diffusion) distances H1 for correspondingly heating another lower-located forming surface 244 nearer to the heating devices 26 might be too short, and their relevant heat-conducting velocities for the lower-located forming surface 244 are too fast; and furthermore, there are some heat-conducting (or thermal diffusion) distances H3 from the heating devices 26, which are in between both of the heat-conducting (or thermal diffusion) distances H1 and H2, for correspondingly heating another middle forming surface 246, and their relevant heat-conducting velocities for the middle forming surface 246 are different from both the above-mentioned heat-conducting velocities. It would make different heating conditions (e.g., different heat-conducting (or thermal diffusion) distances H1, H2, H3 (wherein H3>H2>H1)) provided for those forming surfaces 242, 244, 246, thereby invoking the entire three-dimensional contour shape of the traditional pulp-molding mould 24 being heated unevenly, to also involve the heated time and heated distances of the entire three-dimensional contour dimensions of the respective paper-made article 10 (depicted in FIG. 1) in uneven or inconsistent manner during thermal compression forming/thermal compression shaping. In the case depicted in FIG. 1, although some paper-formed portions (as the portions located correspondingly to the lower-located forming surface 244), nearer to the heating devices 26, of the paper-made article 10 have been fully dried, some other paper-formed portions (as other portions located correspondingly to the higher-located forming surface 242), farther away from the heating devices 26, of the paper-made article 10 have not been dried yet, thereby necessarily extending the heating time of all of the heating devices 26 for making the entire paper-made article 10 being completely dried. It would make its total heating efficiency getting worse, increase a power consumption of its heating supply for dry, increase its heating energy cost, and also consequently extending a total processing cycle time of the respective paper-made articles 10, simultaneously.

Besides, since parts of the respective heating devices 26 mostly belong to stationary structures and shapes which are permanently disposed in the traditional pulp-molding mould assembly 1, and are usable to be easily disassembled and/or assembled, the traditional pulp-molding mould 24 and the heating devices 26 both are in structurally and functionally matched mutually, and all are usable to be randomly modified or replaced for conforming with a shape of any other different paper-made article 10.

Therefore, it is essential to provide an improved pulp-molding mould assembly and its heating device, in order to resolve the above-mentioned various technical matters incurred in the traditional pulp-molding moulds and its heating devices.

### SUMMARY OF THE INVENTION

Hence, to resolve the technical matters of the above-mentioned prior art, a primarily inventive objective of the present invention is to provide a pulp-molding mould assembly with a heating device, which is deployed within a pulp-molding production line to integrally form a plurality of paper-made articles each having three-dimensional contour dimensions. The heating device comprises a number of heating tubes that are layer-by-layer disposed, in an evenly and annularly heating distribution along three-dimensional (3D) directions, around against a three-dimensional contour shape of a three-dimensional inner circumferential surface formed inside a mould (e.g., either of a male mould and a female mould) in the pulp-molding mould assembly, thereby heating an outward three-dimensional contour shape formed, with different level differences, on a forming surface of the mould, to be in a way of achieving the same or the similar heat-conducting (or thermal diffusion) distances from the heating tubes to the forming surface through the mould, and also achieving consistently or evenly heat-conducting velocities from the heating tubes to the forming surface through the mould. By that way, this could further conduct a heat energy, which is heated against the forming surface of the mould by the heating tubes, to dry the entire three-dimensional contour dimensions of the respective paper-made article through the entire three-dimensional contour dimensions contacting against the forming surface of the mould, in a further way of achieving evenly or consistently heating time and heating distances for the heating tubes drying the respective paper-made article through the mould, during a slurry-suctioning and thermal compression forming stage and/or a thermal compression shaping stage.

Furthermore, another inventive objective of the present invention is to provide a pulp-molding mould assembly with a heating device, which is deployed within a pulp-molding production line to produce a plurality of paper-made articles each having three-dimensional contour dimensions, wherein by a way that all of heat-conducting (or thermal diffusion) distances from a number of heating tubes to a three-dimensional contour shape of a forming surface of a mould (either of a male mould and a female mould) of the pulp-molding mould assembly are greatly reduced, heat-conducting (or thermal diffusion) distances from the heating tubes to the entire three-dimensional contour dimensions of the respective paper-made article can also be greatly reduced at the same time. Accordingly, the present invention is capable of greatly reducing a heating time, raising a thermal-diffusion efficiency, and reducing a power consumption, for the heating device applied for heating to dryness of the respective paper-made article, so as to function with a lower energy consumption. And, the present invention is further capable of reducing a drying cycle time for the respective paper-made article, thereby reducing a total production cycle time of the pulp-molding production line so as to accomplish a high-efficient yield of the paper-made articles.

Furthermore, another inventive objective of the present invention is to provide a pulp-molding mould assembly with a heating device, which is deployed within a pulp-molding production line to produce a plurality of paper-made articles each having three-dimensional contour dimensions. A mould (either of the male mould and the female mould) of the pulp-molding mould assembly has a back portion, the inside of which is inwardly hollowed to form a main accommodating chamber serving as a compartment for heat-insulating. The main accommodating chamber is formed therein with a main inner space functioning on a vacuum heat-insulation thereof to accomplish a thermal preservation effect at the same time when the mould heats the respective paper-made article, thereby efficiently insulating the mould from a heat dissipation in the case of overlong contact heat-conducting distances from the mould to its corresponding heating tubes, in the above-mentioned traditional pulp-molding mould assembly 1. Thus, the present invention can further raise a heating efficiency of the heating device, and reduce a power consumption required for heating to dryness, so as to accomplish a low consumption. And simultaneously, by that way of inwardly hollowing inside the back portion of the mould, it is capable of making the mould being weight-lost and thinned, reducing its mould cost, increasing formed depths of the respective product, and decreasing apparatus's carrying capacity and transportation matters.

Furthermore, another objective of the present invention is to provide a pulp-molding mould assembly with a heating device, which is deployed within a pulp-molding production line for producing a plurality of paper-made articles each having three-dimensional contour dimensions, wherein there are a number of heating tubes, which are layer-by-layer arranged in an evenly and annularly heating distribution along three-dimensional (3D) directions inside a mould (either of a male mould and a female mould), electrically connected respectively with a number of temperature controlling circuits operating independently from each other, to be in a way of implement a temperature regulation-and-control for individual excessively heat-concentrating or heat dissipating region in the mould.

Furthermore, another objective of the present invention is to provide a pulp-molding mould assembly with a heating device, which is deployed within a pulp-molding production line for producing a plurality of paper-made articles each having three-dimensional contour dimensions, wherein there are a number of heating tubes arranged in a evenly heating distribution inside a mould (either of a male mould and a female mould) and having a waterproof capability (e.g., in conformity with an international waterproof level of IP67), thereby being not only capable of isolating the vacuum from leakage and facilitating directly clearing and maintenance for the mould (either of the male mould and the female mould) but also accomplishing simply and rapidly modular assembling/disassembling of the heating tubes by way of random constitution and replacement on demands of different paper-made article shapes.

To accomplish the above-mentioned objectives, a preferred embodiment according to the present invention adopts the following technical solution that a pulp-molding mould assembly, which is deployed within a pulp-molding production line to integrally form a plurality of paper-made articles each having three-dimensional contour dimensions, comprises: two paired moulds and a heating device.

The paired moulds operate on die-matching mutually to integrally form the three-dimensional contour dimensions of the respective paper-made article, wherein at least one of the paired moulds has a longitudinal axis line, a top side located perpendicularly to the longitudinal axis line, a back side located oppositely to the top side, and a three-dimensional contour molding structure, which is formed on the top side along the longitudinal axis line, having a forming surface configured on correspondingly shaping a formed circumferential surface of the respective paper-made article.

The heating device is disposed inside the at least one mould, to heat the respective paper-made article through the at least one mould, thereby further indirectly heating the respective paper-made article through the at least one mould, and the heating device comprises a number of heating tubes, and a power source interface configured to electrically connect the heating tubes with an external power source, wherein a main accommodating chamber is formed by way of hollowing inside the at least one mould, between from the forming surface of the three-dimensional contour molding structure to the back side, in a way to define a main inner space and a main three-dimensional inner circumferential surface facing the main inner space. And, the heating tubes are layer-by-layer arranged in an evenly and annularly heating distribution to constitute a multilayer-stacked structure with an annular shape in conformity with a scale of a three-dimensional contour shape of the entire main three-dimensional inner circumferential surface, and the multilayer-stacked structure is detachably assembled within the main inner space of the main accommodating chamber, to make the heating tubes heating and conducting heat against the three-dimensional contour shape of the entire main three-dimensional inner circumferential surface.

Preferably, the main three-dimensional inner circumferential surface is further divided into a number of narrowed sidewalls facing away from the forming surface of the three-dimensional contour molding structure, and a number of widened sidewalls formed between the forming surface and the back side, wherein a partial of the heating tubes of the multilayer-stacked structure are layer-by-layer arranged in an evenly and annularly heating distribution around the narrowed sidewalls and all are kept in an interval distance of 2-5 cm from the forming surface.

Preferably, along the longitudinal axis line, the entire main three-dimensional inner circumferential surface is delimited layer by layer into multilayered annular grooves located at different layer levels, and the heating tubes are disposed respectively inside the multilayered annular grooves of the main three-dimensional inner circumferential surface, to make the heating tubes of the multilayer-stacked structure layer-by-layer surrounding and abutting against the three-dimensional contour shape of the entire main three-dimensional inner circumferential surface, to be in a manner that the heating tubes heat an air, inside the main inner space of the main accommodating chamber, toward a direction which the heating tubes are exposed to the main inner space of the main accommodating chamber, as well as evenly heating and conducting heat against the three-dimensional contour shape of the entire main three-dimensional inner circumferential surface, toward another direction which the heating tubes directly contact against the three-dimensional contour shape of the entire main three-dimensional inner circumferential surface.

Preferably, the at least one mould further has a covering plate which is detachably retained on the back side to air-tightly cover up the main accommodating chamber, and the at least one mould is further air-communicated with a vacuumizing device to create a vacuum environment inside the main inner space of the main accommodating chamber, to be in a manner that when the heating tubes heat the air toward the direction to the main inner space of the main accommodating chamber, a vacuum heat-insulation occurs inside the main accommodating chamber, which is air-tightly covered up by the covering plate, to yield a thermal preservation effect inside the main accommodating chamber.

Preferably, the heating tubes are capable of being moved into/out from the main inner space of the main accommodating chamber, to be directly assembled detachably inside the multilayered annular grooves of the main three-dimensional inner circumferential surface, and to expose the heating tubes, toward the main inner space of the main accommodating chamber, in a manner of evenly heating the air.

Preferably, the at least one mould further comprises a heat-conducting middle body disposed inside the main inner space of the main accommodating chamber and having a secondary three-dimensional outer circumferential surface, in conformity to the scale of the three-dimensional contour shape of the entire main three-dimensional inner circumferential surface, under a manner of directly contacting with the main three-dimensional inner circumferential surface, and a back portion of the heat-conducting middle body is inwardly hollowed to form a secondary accommodating chamber which defines a secondary inner space and a secondary three-dimensional inner circumferential surface facing the secondary inner space but facing away from the secondary three-dimensional outer circumferential surface, wherein along the longitudinal axis line, the entire secondary three-dimensional outer circumferential surface is delimited layer by layer into multilayered annular grooves located at different layer levels, and the heating tubes are respectively layer-by-layer arranged inside the multilayered annular grooves of the secondary three-dimensional outer circumferential surface, to make the heating tubes of the multilayer-stacked structure layer-by-layer surrounding and abutting against a three-dimensional contour shape of the entire secondary three-dimensional outer circumferential surface, to be in a manner that the heating tubes all evenly heat the air toward a direction to the secondary inner space of the secondary accommodating chamber, as well as evenly heating and conducting heat, toward another direction to directly contact against the three-dimensional contour shape of the entire secondary three-dimensional outer circumferential surface, to make indirectly and evenly thermal diffusion onto the main three-dimensional inner circumferential surface.

Preferably, the at least one mould is further air-communicated with a vacuumizing device to create a vacuum environment inside both the main inner space of the main accommodating chamber and the secondary inner space of the secondary accommodating chamber, and the at least one mould further has a covering plate to be in a manner that when the heating tubes evenly heat the air toward the direction to the secondary inner space of the secondary accommodating chamber, a vacuum heat-insulation occurs inside both the main accommodating chamber and the secondary accommodating chamber, which are air-tightly covered up by the covering plate, to yield a thermal preservation effect inside both the main accommodating chamber and the secondary accommodating chamber.

Preferably, the heating tubes are capable of being moved into/out from the main inner space of the main accommodating chamber, to be directly assembled detachably between both of the multilayered annular grooves of the secondary three-dimensional outer circumferential surface and the main three-dimensional inner circumferential surface, for evenly heating.

Preferably, the main three-dimensional inner circumferential surface is formed to be one of a conical inner circumferential surface, a cambered inner circumferential surface, a cuboidal inner circumferential surface, a cubical inner circumferential surface, a cylindrical inner circumferential surface, a concave inner circumferential surface, a convex inner circumferential surface, and other geometric-shape inner circumferential surface.

Preferably, at least one of the heating tubes is extended in an outermost annular perimeter different from an outermost annular perimeter in which another one of the heating tubes is extended.

Preferably, the heating device further comprises at least one temperature sensing member and a temperature regulation-and-control module, the at least one temperature sensing member is capable of being selectively disposed within the at least one mould, to detect a local temperature from a local area of the at least one mould, which the at least one temperature sensing member is located adjacent to, and then to send a temperature-sensing signal indicative of the local temperature to the temperature regulation-and-control module, whereby the temperature regulation-and-control module, in accordance with the temperature-sensing signal, regulates and controls a power intensity output from the external power source, thereby further regulating and controlling, through the power source interface, a heating temperature of the respective heating tube located adjacent to the at least one temperature sensing member.

Preferably, the heating device comprises a plurality of temperature controlling circuits each operating, independently of the other temperature controlling circuits, in a manner of independently regulating and controlling the heating temperature of corresponding one of the heating tubes.

Preferably, the at least one mould is a male mould, and the three-dimensional contour molding structure is a protrudent structure, which is outwardly protruded from the top side along the longitudinal axis line, having an outer forming surface thereon for shaping an inner formed circumferential surface of the respectively paper-made article, wherein the main accommodating chamber is formed, between from the outer forming surface of the protrudent structure to the back side, by way of hollowing inside the male mould.

Preferably, the at least one mould is a female mould, and the three-dimensional contour molding structure is a cavity structure, which is inwardly caved from the top side along the longitudinal axis line, having an inner forming surface thereon for shaping an outer formed circumferential surface of the respective paper-made article, wherein the main accommodating chamber is formed, between from the inner forming surface of the cavity structure to the back side, by way of hollowing inside the female mould.

Besides, another preferred embodiment according to the present invention adopts the following technical solution that a pulp-molding mould assembly, which is deployed within a pulp-molding production line to integrally form a plurality of paper-made articles each having three-dimensional contour dimensions, comprises: two paired moulds and a heating device.

The paired moulds operate to be die-matched mutually for shaping the respective paper-made article, thereby integrally forming the three-dimensional contour dimensions of the respective paper-made article, wherein at least one of the paired moulds has a longitudinal axis line, a top side located perpendicularly to the longitudinal axis line, a back side located oppositely to the top side, and a three-dimensional contour molding structure, which is formed on the top side along the longitudinal axis line, having a forming surface configured on correspondingly shaping a formed circumferential surface of the respective paper-made article.

The heating device is disposed within the at least one mould, to be in a way of heating the respective paper-made article through the at least one mould, and the heating device comprises a number of heating tubes, and a number of power source interfaces configured to electrically connect the heating tubes respectively with an external power source, wherein a plurality of grooves are formed, between from the forming surface of the three-dimensional contour molding structure to the back side, in an even distribution inside the at least one mould, and are in parallel but discommunication with each other, to be in a way of making the heating tubes being detachably disposed, one-to-one, inside the grooves, and the heating device further comprises a plurality of temperature controlling circuits each operating, independently of the other temperature controlling circuits, in a manner of independently regulating and controlling a heating temperature of corresponding one of the heating tubes.

Preferably, by a number of different layer levels where the grooves are respectively located inside the at least one mould, an inside of the at least one mould is delimited layer by layer into the grooves along the longitudinal axis line.

Preferably, the heating device further comprises at least one temperature sensing member and a temperature regulation-and-control module, the at least one temperature sensing member is detachably arranged within at least one of the grooves, and operates to detect a local temperature from a local area of the at least one mould, which the at least one temperature sensing member is located adjacent to, and then to send a temperature-sensing signal indicative of the local temperature to the temperature regulation-and-control module, whereby the temperature regulation-and-control module, in accordance with the temperature-sensing signal, regulates and controls a power intensity output from the external power source, thereby further regulating and controlling, through the power source interface, a heating temperature of the respective heating tube located adjacent to the at least one temperature sensing member, and the temperature regulation-and-control module further comprises the temperature controlling circuits operating independently of each other.

Preferably, the respective heating tube is rendered in a straight rod-like structure.

Preferably, the heating tubes all are kept in an interval distance of 2-5 cm from the forming surface.

Preferably, the grooves all are straightly extended through an outermost sidewall of the at least one mould, to form a number of corresponding through bores on the outermost sidewall, such that the heating tubes are directly and straightly inserted into or drawn out the grooves through the corresponding through bores.

In comparison with the above-mentioned prior arts, a pulp-molding mould assembly having a heating device, according to the present invention, is capable of bringing the following several beneficial technical effects that: (1) by way of layer-by-layer disposals of a number of heating tubes of the heating device in an even distribution around against an inward three-dimensional contour shape of a three-dimensional inner circumferential surface formed on a mould (e.g., either of a male mould and a female mould) of a pulp-molding mould assembly in a pulp-molding production line, an outward three-dimensional contour shape of a forming surface of the mould can be evenly heated to achieve the same or the similar heat-conducting distances, and consistently or evenly heat-conducting velocities, from the heating tubes to the forming surface through the mould, thereby further greatly reducing the heat-conducting distances from the heating tubes to the entire three-dimensional contour dimensions of the respective paper-made article, to be in a way of greatly reducing a heating time of the heating device, raising a thermal-diffusion efficiency, reducing a power consumption required for heating to dryness and thereby accomplishing a low consumption objective; (2) it is capable of reducing a drying cycle time for the respective paper-made article, thereby being further capable of reducing an overall production cycle time of the pulp-molding production line, to accomplish a high-efficient yield of the paper-made articles; (3) while the inside of the mould is heated by the heating device for heating to dry the respective paper-made article, it is capable of accomplishing a thermal preservation effect by way of a vacuum heat-insulation thereof, which reduce heat dissipation in case of overlong contact distances serving as heat-conducting distances from the heating tubes to the inside of the mould, thereby further raising a heating efficiency of the heating device, reducing a power consumption required for heating to dryness, and thereby accomplishing a low consumption objective, wherein by way of inwardly hollowing inside a back portion of the mould, it is capable of making the mould being weight-lost and thinned, thereby reducing its mould cost, increasing formed depths of the respective product, and reducing an apparatus carrying capacity and transportation matters; (4) the heating tubes arranged in an evenly and annularly heating distribution along three-dimensional (3D) direction inside the mould are electrically connected respectively with a number of temperature controlling circuits operating, independently from each other, to be in a way of individually implementing a temperature regulation-and-control on respective excessively heat-concentrating or heat dissipating region in the mould; and (5) the heating tubes have a waterproof capability (e.g., in conformity with the international waterproof level of IP67) of not only isolating the vacuum from leakage, and facilitating directly clearing and maintenance on the mould but also accomplishing simply and rapidly modular assembling/disassembling of the heating tubes, to be in a way of random constitution and replacement on demands of different paper-made article shapes.

### DESCRIPTION OF THE DIAGRAMS

To more definitely explain respective embodiments or the prior arts, the figures described in the embodiments or the prior art would be simply introduced thereinafter. It should be realized that the following descriptions for the embodiments and their relevant figures are rendered only for exemplifying the present invention but not for defining the claim scope of the present invention.

FIG. 1 depicts a schematic cross-sectional diagram of a traditional pulp-molding mould assembly where a variety of different-distance heating routes are illustrated;

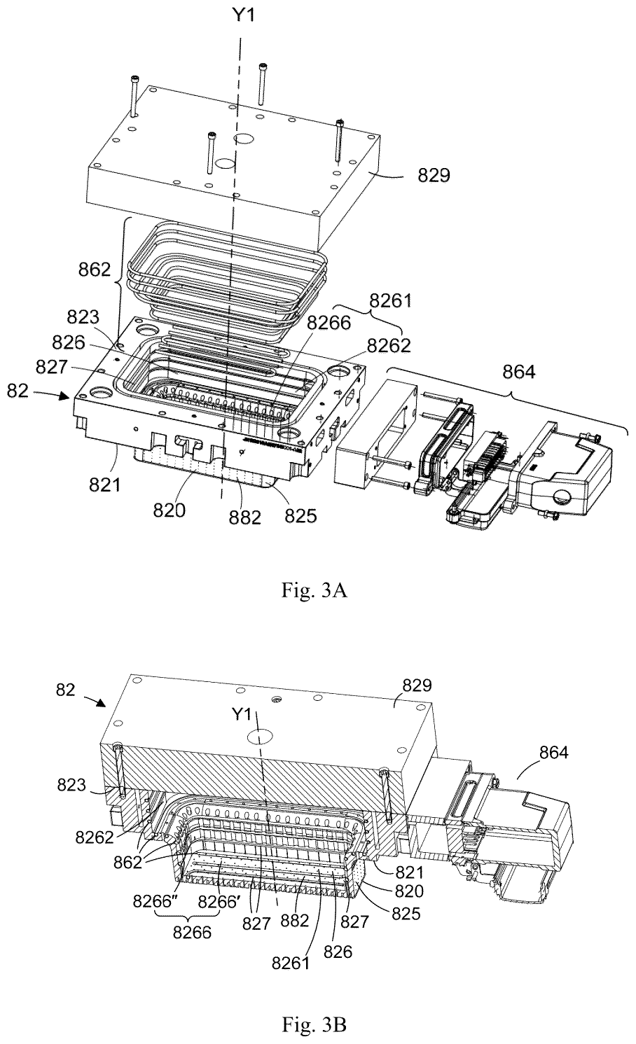

FIG. 2 depicts a top view of a pulp-molding mould assembly, with a heating device, of a first preferred embodiment according to the present invention;

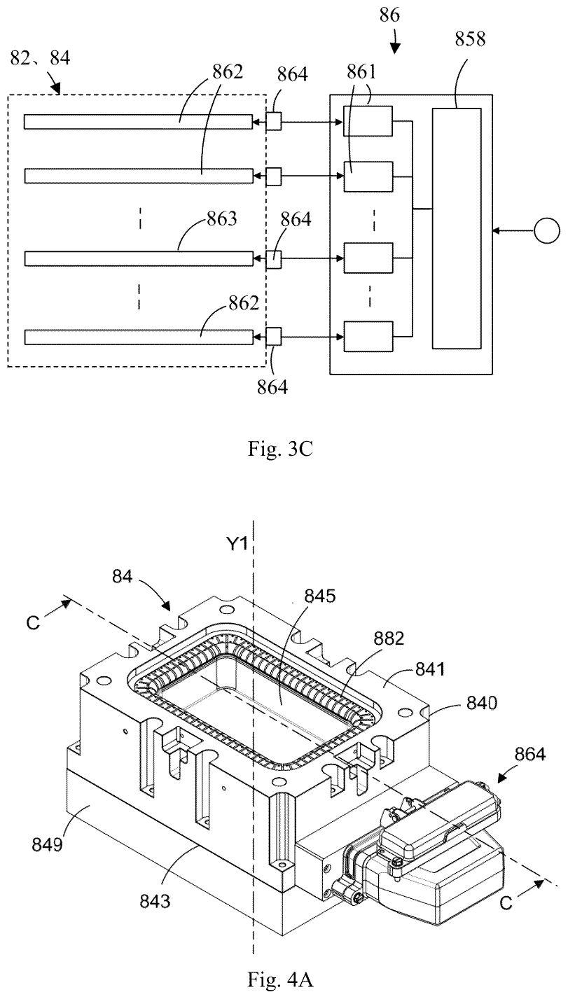

FIG. 3A depicts an element-exploded diagram of a male mould in accordance with the pulp-molding mould assembly shown in FIG. 2;

FIG. 3B depicts a laterally cross-sectional diagram in accordance with a sectioning line B-B drawn on the male mould shown in FIG. 2;

FIG. 3C depicts a structurally schematic diagram of a heating device in accordance with the male mould shown in FIG. 3A;

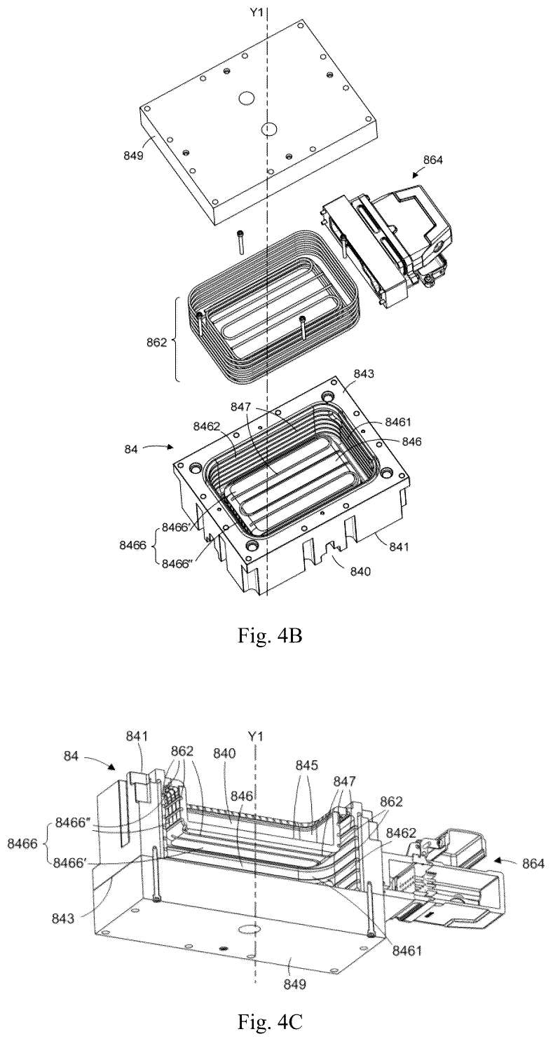

FIG. 4A depicts a pictorial view of a female mould in a pulp-molding mould assembly, with a heating device, of a second preferred embodiment according to the present invention;

FIG. 4B depicts an element-exploded diagram of the female mould shown in FIG. 4A;

FIG. 4C depicts a laterally cross-sectional diagram in accordance with a sectioning line C-C drawn on the female mould shown in FIG. 4A;

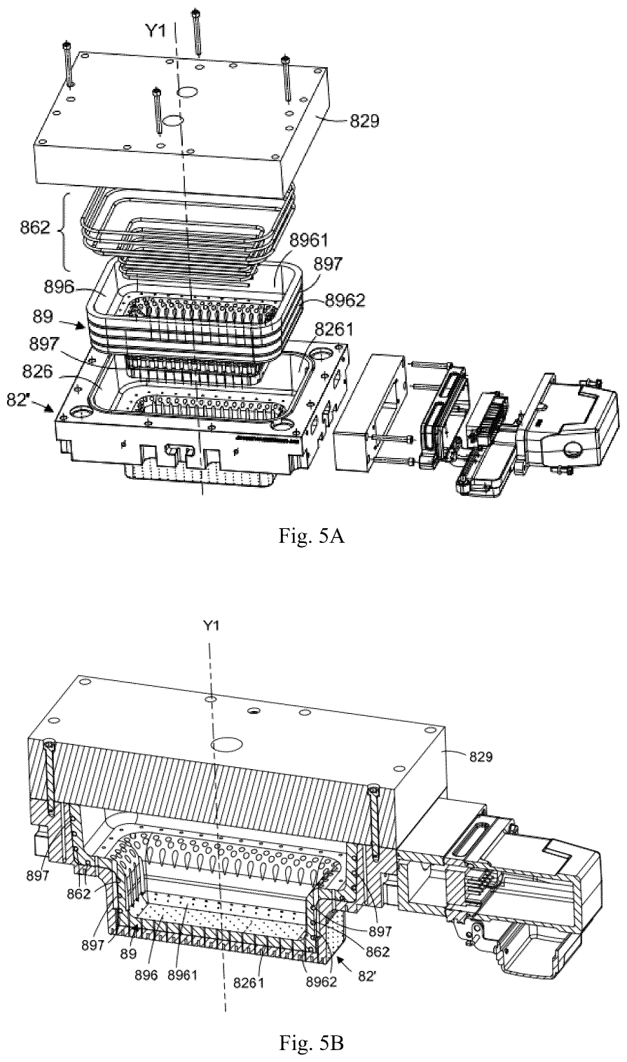

FIG. 5A depicts an element-exploded diagram of a male mould of a third preferred embodiment according to the present invention;

FIG. 5B depicts a laterally cross-sectional diagram of the male mould shown in FIG. 5A after assembly;

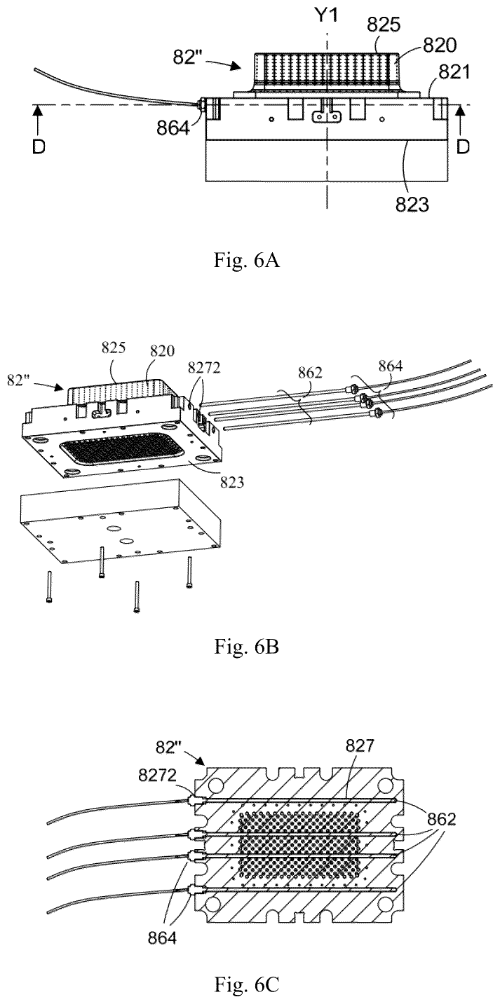

FIG. 6A depicts a laterally pictorial view of a male mould of a fourth preferred embodiment according to the present invention;

FIG. 6B depicts an element-exploded diagram of the male mould shown in FIG. 6A;

FIG. 6C depicts a transversally cross-sectional diagram in accordance with a sectioning line D-D drawn on the male mould shown in FIG. 6A;

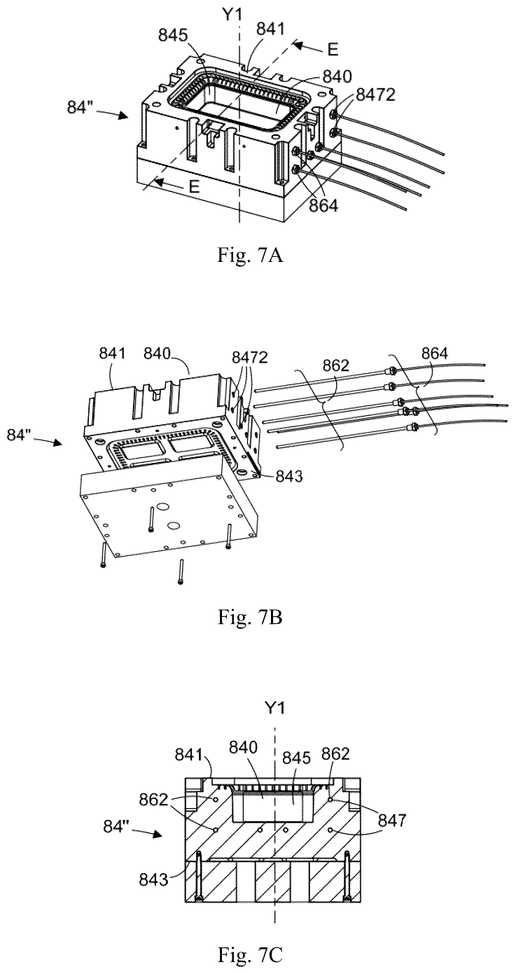

FIG. 7A depicts a pictorial view of a female mould of a fifth preferred embodiment according to the present invention;

FIG. 7B depicts an element-exploded diagram of the female mould shown in FIG. 7A; and

FIG. 7C depicts a laterally cross-sectional diagram in accordance with a sectioning line E-E drawn on the female mould shown in FIG. 7A.

### DETAILED DESCRIPTION OF THE PREFERRED EMBODIMENTS

The respective preferred embodiments and their companying drawings according to the present invention are further described below only for making the person, which has an ordinary skill in a technique art which the present invention pertains to, accomplishing enablement according to the present invention. The respective preferred embodiment exemplified in accordance with the present invention should not be regarded as a limitation to the claim scope of the present invention. In the following descriptions for the present invention, it should be realized that, a variety of directional terms mentioned in the present invention, comprise but do not limit to, such as “center”, “upward”, “downward”, “front”, “rear”, “left”, “right”, “top”, “bottom”, “inside”, “outside” and so forth, on the basis of these directional positions or remove indicated relative to the depictions of the attached figures, only for facilitating a simplified description to the present invention but not indicating or hinting that the mentioned device or component has to be located at a specific directional position, or moved in a specific direction. Thus, it should not be realized as the limitations to the claim scope of the present invention. Besides, another terms, such as “first”, “second” and so forth are described only for distinguishing objects but not indicating or hinting the amount of some technical characterizations, and therefore the respective technical characterization with respectively specifying the terms “first” and “second” is capable of indicating or hinting that its amount may be just one or multiple of the technical characterization, unless there are definitely and concretely claim-limited to the amount of the respective technical characterization.

Please firstly refer to FIG. 2, which depicts a top view of a pulp-molding mould assembly 70 of a first preferred embodiment according to the present invention. The pulp-molding mould assembly 70 is applied to deploy within a slurry-suctioning and thermal compression forming stage and/or a thermal compression shaping stage of a pulp-molding production line, for integrally forming a plurality of paper-made articles each having three-dimensional contour dimensions (not shown), and is configured to automatically produce mass of the paper-made articles each formed per a specific producing cycle time. In the present preferred embodiment, the pulp-molding production line can be a traditional or an improved pulp-molding production line that adopts a wet-type pulp-molding technique. Hereinafter the so-called “paper-made article” generally refers to a wet rough body, a semi-finished article, a finished article or any kind of article made, from plant fibers (e.g., bamboo fibers or bagasse fibers) treated as a main raw material, correspondingly by any one of working stages in the pulp-molding production line; especially, the paper-made articles can further accomplish biodegradability or bio-compostability. In the present preferred embodiment, the three-dimensional contour dimensions of the respective paper-made article can be but not limited to, for example, a cup-like shape, a pillar shape, a disk-like shape, a lid-like shape, a box-like shape, a cambered shape, a triangle shape, a cone shape, a cubical shape, a cuboidal shape, or any another paper-made container or paper-made packaging having irregularly geometrical dimensions.

As depicted in FIG. 2, the pulp-molding mould assembly 70 is principally constructed of: two paired male mould 82 and female mould 84, a heating device 86 and a vacuumizing device 88. In the present preferred embodiment, the male mould 82 and the female mould 84 both, which are principally equipped in the slurry-suctioning and thermal compression forming stage and/or thermal compression shaping stage of the pulp-molding production line, operate on die-matching mutually for applying compressive forces and heating (namely a so-called “thermal compression”) onto the respective paper-made article, simultaneously. Therefore, it is not limited to arrange both of the male mould 82 and female mould 84 in an upper-to-lower or a lower-to-upper deployment while applying thermal compression by the die-matching thereof. In the present preferred embodiment, the mutually die-matching between both the male mould 82 and the female mould 84 thermally compress the respective paper-made article to integrally form overall inner/outer shapes, with the three-dimensional contour dimensions, of the respective paper-made article. Therefore, the here-called “three-dimensional contour molding structure” generally refer to a number of (inner/outer) shapes and dimensions of at least one of the male mould 82 and the female mould 84, and need to be in conformity with a scale of overall inner/outer shapes and three-dimensional contour dimensions of the respective paper-made article. The at least one mould (either of the male mould 82 and the female mould 84) has a three-dimensional contour molding structure further formed with a forming surface configured for correspondingly shaping a formed circumferential surface of the respective paper-made article. In details, the here-called “forming surface” is defined as a surface region of the at least one mould, which directly thermally compressively contacts with the respective paper-made article (by the face-to-face die-matching together with the other mould), thereby forming the three-dimensional contour dimensions of an inner/outer formed circumferential surface of the respective paper-made article.

As the present preferred embodiment depicted in FIGS. 2 and 3A-3B, FIG. 3A depicts an element-exploded diagram of the male mould 82 of the pulp-molding mould assembly 70 shown in FIG. 2, and FIG. 3B depicts a laterally cross-sectional diagram in accordance with a sectioning line B-B drawn on the male mould 82 shown in FIG. 2. At least one of the two paired moulds 82, 84, e.g., the male mould 82, has a longitudinal axis line Y1 (namely a line which can be regarded as a longitudinally die-matching axis line passing through both the male and female moulds 82, 84), a top side 821 located perpendicularly to the longitudinal axis line Y1, a back side 823 located oppositely to the top side 821, and a three-dimensional contour molding structure formed on the top side 821 along the longitudinal axis line Y1 (which will be detailed later). In the present preferred embodiment, the three-dimensional contour molding structure of the male mould 82 can be realized as a protrudent structure 820 outwardly protruded from the top side 821 along the longitudinal axis line Y1. And therefore, the forming surface of the three-dimensional contour molding structure of the male mould 82 can also be realized as an outer forming surface 825, formed around the protrudent structure 820, for correspondingly shaping an inner formed circumferential surface of the respective paper-made article.

Please Further referring to FIGS. 3A-3B, a main accommodating chamber 826 is formed, between from the outer forming surface 825 of the protrudent structure 820 to the back side 823, by way of inwardly hollowing inside a back portion of the male mould 82, and serves as a corresponding compartment for achieving a heat-insulation. Preferably, the male mould 82 further has a covering plate 829 which is detachably fixed (e.g., by fixing screws) onto the back side 823, to make the covering plate 829 air-tightly covering up the main accommodating chamber 826. By that way of inwardly hollowing inside the back portion of the male mould 82 to form the main accommodating chamber 826, it is capable of making the male mould 82 being weight-lost and thinned, reducing a material cost of the male mould 82, increasing formed depths of the respective product, and reducing an apparatus carrying capacity and transportation matters.

As depicted in FIGS. 3A-3B, the main accommodating chamber 826 is defined therein with a main inner space and a main three-dimensional inner circumferential surface 8261 facing the main inner space; preferably, the main three-dimensional inner circumferential surface 8261 might be one of a cup-shaped inner circumferential surface, a cylindrical inner circumferential surface, a disk-shaped inner circumferential surface, a lid-shaped inner circumferential surface, a box-shaped inner circumferential surface, a cambered inner circumferential surface, a triangle-shaped inner circumferential surface, a conical inner circumferential surface, a cuboidal inner circumferential surface, a cubical inner circumferential surface, a concave inner circumferential surface, a convex inner circumferential surface, and other geometric-shape inner circumferential surface. The main three-dimensional inner circumferential surface 8261 overall is delimited layer by layer, along the longitudinal axis line Y1, into a plurality of grooves 827 located, in parallel but discommunication with each other, at different layer levels (namely the longitudinal axis line Y1 serving as a datum-level line). As to the present preferred embodiment depicted in FIGS. 3A-3B, the main three-dimensional inner circumferential surface 8261 overall is delimited layer by layer, along the longitudinal axis line Y1, into multilayered annular grooves 827 located at different layer levels (namely the longitudinal axis line Y1 serving as a datum-level line), whereby the multilayered annular grooves 827 can be evenly and annularly arranged around a three-dimensional contour shape of the entire main three-dimensional inner circumferential surface 8261 along a three-dimensional direction thereof, and the multilayered annular grooves 827 are arranged layer-by-layer, along the longitudinal axis line Y1, in a direction parallel but discommunicated with each other, and each two of parallel annular grooves 827 are spaced with a fixed interval therebetween.

As the present preferred embodiment depicted in FIGS. 3A-3B, since the main three-dimensional inner circumferential surface 8261 is further divided into a number of widened sidewalls 8262 formed between the top side 821 and the back side 823, and a number of narrowed sidewalls 8266 facing away from the outer forming surface 825 of the protrudent structure 820; preferably, the narrowed sidewalls 8266 further comprises a narrowed bottom sidewall 8266′ transversally formed, and a number of laterally-narrowed sidewalls 8266″ longitudinally formed around the narrowed bottom sidewall 8266′, such that the multilayered annular grooves 827 are evenly and annularly arranged around the entire three-dimensional contour shapes of both the widened sidewalls 8262 and the narrowed sidewalls 8266 (comprising the narrowed bottom sidewall 8266′ and the laterally-narrowed sidewalls 8266″) along a three-dimensional direction thereof.

Further referring to the present preferred embodiment depicted in FIGS. 2 & 3A-3C, the heating device 86 is principally constructed of: a number of heating tubes 862 and a power source interface 864. The heating tubes 862 and the power source interface 864 all are disposed within the male mould 82, wherein the heating tubes 862 all are layer-by-layer arranged in an evenly and annularly heating distribution around the main three-dimensional inner circumferential surface 8261 of the main accommodating chamber 826 formed inside the male mould 82. The power source interface 864 as shown FIG. 3C is disposed within an outermost lateral side of the male mould 82, and is configured for electrically connecting the heating tubes 862 to an external power source (not shown), through a way of increasing or reducing a heating temperature generated from the respective heating tubes 862, in accordance with a power intensity output from the external power source, whereby at the same time while the paired moulds 82, 84 are die-matched mutually for compressively-forming the respective paper-made article, the heating device 86 also heats the male mould 82 (e.g., in the slurry-suctioning and thermal compression forming stage and/or thermal compression shaping stage of the pulp-molding production line), the heating tubes 862 heat inside the male mould 82 so as to further conduct heat (as indirectly heating) to the respective paper-made article, through the heated male mould 82 contacting with the respective paper-made article, thereby removing moistures and/or vapors contained within the respective paper-made article.

In assembly as depicted in FIGS. 3A-3B, the heating tubes 862 are layer-by-layer arranged, in an evenly and annularly heating distribution along the longitudinal axis line Y1, into a multilayer-stacked structure with an annular shape in conformity to a scale of the entire three-dimensional contour shape of the main three-dimensional inner circumferential surface 8261. All of the heating tubes 862 of the multilayer-stacked structure can be moved into/out, through the back side 823 of the male mould 82, from the main inner space of the main accommodating chamber 826, in order to make the heating tubes 862 having a capability of being directly detachably assembled inside the main inner space of the main accommodating chamber 826. And, such an evenly and annularly heating distribution of the heating tubes 862 that are respectively disposed inside the multilayered annular grooves 827 of the main three-dimensional inner circumferential surface 8261, it is capable of accomplishing simply and rapidly modular assembling/disassembling of the heating tubes 862, to be in a way of random constitution and replacement on demands of different paper-made article shapes. By way of the multilayered annular grooves 827 being arranged in parallelly fixed intervals and discommunication with each other, the heating tubes 862 that are assembled into the multilayer-stacked structure, as stacked layer by layer, are also kept in parallelly fixed intervals and discommunication with each other (namely without establishment of electrically and/or mechanically connection). After the heating tubes 862 are assembled, the heating tubes 862 do not only evenly heat and conduct heat against the entire three-dimensional contour shape of the main three-dimensional inner circumferential surface 8261, in a direction which the heating tubes 862 directly contact against the entire three-dimensional contour shape of the main three-dimensional inner circumferential surface 8261, but the heating tubes 862 are also capable of evenly heating an air inside the main inner space of the main accommodating chamber 826, in another direction which the heating tubes 862 are exposed to the main inner space of the main accommodating chamber 826. Preferably, the heating tubes 862 that are layer-by-layer arranged in an evenly and annularly heating distribution inside the male mould 82 have a waterproof capability (e.g., in conformity with the international waterproof level of IP67), thereby being capable of isolating the vacuum thereof from leakage, and facilitating easy clearing and maintenance for the male mould 82.

By way of inwardly hollowing inside the back portion of the male mould 82 to form the main accommodating chamber 826, and arranging the heating tubes 862 in an evenly and annularly heating distribution around the entire three-dimensional contour shape of the main three-dimensional inner circumferential surface 8261 of the male mould 82 along the three-dimensional (3D) direction thereof, a plurality of different level regions located at the three-dimensional contour shape of the outer forming surface 825 of the male mould 82 all have the same or the similar heat-conducting (or thermal diffusion) distances relative to the corresponding heating tubes 862. Accordingly, while the male mould 82 thermally compresses the respective paper-made article during the slurry-suctioning and thermal compression forming stage and/or thermal compression shaping stage, it would make consistently heat-conducting velocities and evenly heating from the corresponding heating tubes 862 to the respective regions of the three-dimensional contour shape of the outer forming surface 825 of the male mould 82, and thereby further expediting the male mould 82 providing evenly or consistently heated time and heated distances for each place of the entire three-dimensional contour dimensions, with corresponding to the heating tubes 862, of the respective paper-made article. Furthermore, the overall heat-conducting (or thermal diffusion) distances for the three-dimensional contour shape, with corresponding to the heating tubes 862, of the outer forming surface 825 all can be greatly reduced simultaneously, to serve as greatly reducing the overall heat-conducting (or thermal diffusion) distances for the entire three-dimensional contour dimensions, with corresponding to the heating tubes 862, of the respective paper-made article. Therefore, it is capable of greatly reducing the overall heating time, raising its thermal diffusion efficiency, reducing a power consumption required for heating to dryness, and thereby accomplishing a low consumption objective, for the heating device 86; simultaneously, it is further capable of reducing a drying cycle time for the respective paper-made article, and thereby reducing a total production cycle time of the pulp-molding production line, in order to accomplish a high-efficient yield of the paper-made articles.

Besides, referring to the present preferred embodiment depicted in FIGS. 2 & 3A-3B, the pulp-molding mould assembly 70 further comprises a vacuumizing device 88 which is air-communicated with a number of micro vents 882, formed through the male mould 82, via a number of conduits, thereby creating a vacuum environment inside the main inner space of the main accommodating chamber 826, to be in a way of expeditiously removing and exhausting moistures and/or vapors, contained within the respective paper-made article, through the male mould 82. Finally, the respective dried paper-made article is formed from dried plant fibers (e.g., in the above-mentioned slurry-suctioning and thermal compression forming stage and/or thermal compression shaping stage). At the same time while vacuumizing device 88 proceeds on vacuumizing the main inner space of the main accommodating chamber 826, the heating tubes 862 also evenly heat toward the main inner space of the main accommodating chamber 826 through the air inside the main inner space, to make the main accommodating chamber 826, which is air-tightly covered up by the covering plate 829, yielding a thermal preservation effect by way of a vacuum heat-insulation thereof. Therefore, it could insulate the heat from dissipation in case of overlong heat-conducting distances from the heating tubes 862 to the outer forming surface 825 of the male mould 82, thereby further raising a heating efficiency, reducing a power consumption required for heating to dryness, and thereby accomplishing a low consumption, for the heating device 86.

In details, as depicted in FIGS. 3A-3B, all the heating tubes 862 of the multilayer-stacked structure tightly abut against and layer-by-layer surround the entire three-dimensional contour shapes of both the widened sidewalls 8262 and the narrowed sidewalls 8266 of the main three-dimensional inner circumferential surface 8261 (comprising the narrowed bottom sidewall 8266′ and the laterally-narrowed sidewalls 8266″) of the male mould 82 along a three-dimensional (3D) direction thereof, in order to accomplish an evenly and annularly heating distribution around the entire three-dimensional contour shapes. Preferably, annularly inner perimeters of both the widened sidewalls 8262 and the narrowed sidewalls 8266 are different from each other, such that outermost annular perimeters of a partial of the heating tubes 862 layer-by-layer arranged in an evenly and annularly heating distribution around the annularly inner perimeter of the widened sidewalls 8262 are also different from (as being larger than) outermost annular perimeters of another partial of the heating tubes 862 layer-by-layer arranged in an evenly and annularly heating distribution around the annularly inner perimeter of the narrowed sidewalls 8266. Preferably, the outermost annular perimeter of each of the heating tubes 862 annularly arranged around the annularly inner perimeters of both the widened sidewalls 8262 and the narrowed sidewalls 8266 are rendered in a “□”-shaped structure. Preferably, the heating tubes 862 all, which are layer-by-layer arranged in an evenly and annularly heating distribution around the narrowed sidewalls 8266, are kept in an interval distance of 2-5 cm from the outer forming surface 825 but not limited to this interval distance.

Further referring to FIGS. 3A-3B, since the annularly inner perimeters of both the narrowed bottom sidewall 8266′ and the laterally-narrowed sidewalls 8266″ of the narrowed sidewalls 8266 are different from each other in their structures and shapes, the outermost annular perimeters of the heating tubes 862 evenly and layer-by-layer arranged in an evenly and annularly heating distribution around the laterally-narrowed sidewalls 8266″ are different from (as being larger than) the outermost annular perimeters of the heating tubes 862 layer-by-layer arranged in an evenly and annularly heating distribution around the narrowed bottom sidewall 8266′ in their structures and shapes. Preferably, the outermost annular perimeter of each of the heating tubes 862 annularly arranged around the annularly inner perimeter of the narrowed bottom sidewall 8266′ is rendered in a U-shaped structure. In another embodiment, the outermost annular perimeter of each of a partial of the heating tubes 862 annularly arranged around the annularly inner perimeter of the narrowed bottom sidewall 8266′ can also be rendered in a S-shaped structure.

Further referring to FIGS. 2 & 3C, the heating device 86 further comprises at least one temperature sensing member 863 and a temperature regulation-and-control module 858. As depicted in FIGS. 3B-3C, the at least one temperature sensing member 863 is capable of being selectively disposed inside the male mould 82. For example, the at least one temperature sensing member 863 might be one or a plurality of temperature sensing members 863 respectively detachably arranged inside a partial of the corresponding annular grooves 827 formed around the main three-dimensional inner circumferential surface 8261 of the male mould 82 (or configured to replace a partial of the heating tubes 862 which is/are originally disposed inside the corresponding annular grooves 827), thereby detecting a local temperature from a local area of the mould 82, which the at least one temperature sensing member 863 is located adjacent to, and then sending a temperature-sensing signal indicative of the local temperature to the temperature regulation-and-control module 858. The temperature regulation-and-control module 858 as a temperature controlling member might be one of a programmable logic controller (PLC), a microcontroller unit (MCU), a single-chip microcomputer (SOC) and a traditional computerized module, and so forth. As shown in FIG. 3C, dependent on the temperature-sensing signal sent from the temperature sensing member 863, the temperature regulation-and-control module 858 regulates and controls the power intensity (e.g., a scale of a supply current or voltage) of the external power source (not shown), and then the regulated-and-controlled power intensity is fed back, through the power source interface 864, to vary a scale of a heating temperature generated from the respective heating tubes 862 located adjacent to the local area of the mould 82, where the at least one temperature sensing member 863 is located adjacent. Preferably, as depicted in FIGS. 3B-3C, the heating devices 86 further comprises a plurality of temperature controlling circuits 861, which operate independently of each other, each configured for independently regulating and controlling a heating temperature generated from corresponding one of the heating tubes 862. The temperature controlling circuits 861 operating independently of each other, are electrically connected to the temperature regulation-and-control module 858, whereby the temperature regulation-and-control module 858 can implement temperature-controlling individually for the corresponding one of the heating tubes 862, through the individual temperature controlling circuit 861 operating independently from temperature regulation-and-control of the other temperature controlling circuits 861. Within the male mould 82, it is capable of implementing individually a temperature regulation-and-control for individual excessively heat-concentrating region or excessively heat-dissipating region. Therefore, in comparison with the traditional mould-heating device, the heating device 86 of the present invention, through the at least one temperature sensing member 863 and the temperature controlling circuits 861 operating independently of each other, is capable of further greatly reducing a power consumption, required for heating to dryness, to accomplish a low consumption, and simultaneously reducing a drying cycle time for the respective paper-made article, to thereby reduce a total production cycle time of the pulp-molding production line, in order to accomplish a high-efficient yield of the paper-made articles.

Besides, further referring to an illustration depicted in FIGS. 2 & 4A-4B, FIG. 4A depicts a pictorial view of the female mould 84 of the pulp-molding mould assembly 70, with a heating device 86, of a second preferred embodiment according to the present invention, and FIG. 4B depicts an element-exploded diagram of the female mould 84 shown in FIG. 4A. As depicted in FIG. 2, the other mould in the paired moulds 82, 84, namely the female mould 84, similarly has a longitudinal axis line Y1, a top side 841 located perpendicularly to the longitudinal axis line Y1, a back side 843 located oppositely to the top side 841, and a three-dimensional contour molding structure (detailed later) formed on the top side 841 along the longitudinal axis line Y1. In the present preferred embodiment, the three-dimensional contour molding structure of the female mould 84 has a cavity structure 840 which is inwardly caved from the top side 841 along the longitudinal axis line Y1, whereby a forming surface of a three-dimensional contour molding structure of the female mould 84 can be realized as an inner forming surface 845 formed around and inside the cavity structure 840, for correspondingly shaping an outer formed circumferential surface of the respective paper-made article.

Referring to the present preferred embodiment depicted in FIGS. 4A-4C, FIG. 4C depicts a laterally cross-sectional diagram in accordance with a sectioning line C-C drawn on the female mould 84 shown in FIG. 4A. A main accommodating chamber 846 serving as an air-isolating chamber is formed, between from the inner forming surface 845 of the cavity structure 840 to the back side 843, by way of inwardly hollowing inside a back portion of the female mould 84. Preferably, the female mould 84 further has a covering plate 849, which is detachably fixed (e.g., by fixing screws) onto the back side 843, to make the covering plate 849 air-tightly covering up the main accommodating chamber 846. By that way of inwardly hollowed inside the back portion of the female mould 84 to form the main accommodating chamber 846, the present invention is capable of making the female mould 84 being weight-lost and thinned, reducing a material cost of the female mould 84, increasing formed depths of the respective product, and reducing an apparatus carrying capacity and transportation matters.

As depicted in FIGS. 4B-4C, the main accommodating chamber 846 is defined therein with a main inner space and a main three-dimensional inner circumferential surface 8461 (as an inner circumferential surface) facing the main inner space. Preferably, the main three-dimensional inner circumferential surface 8461 can be one of a cup-shaped inner circumferential surface, a cylindrical inner circumferential surface, a disk-shaped inner circumferential surface, lid-shaped inner circumferential surface, box-shaped inner circumferential surface, a camber-shaped inner circumferential surface, a triangle-shaped inner circumferential surface, a conical inner circumferential surface, a cuboidal inner circumferential surface, a cubical inner circumferential surface, a concave inner circumferential surface, a convex inner circumferential surface, and other geometric-shape inner circumferential surface. The main three-dimensional inner circumferential surface 8461 overall is delimited layer by layer, along the longitudinal axis line Y1, into a plurality of grooves 847 located at different layer levels (namely the longitudinal axis line Y1 serving as a datum-level line), and in parallel but discommunication with each other. In further details as depicted in FIGS. 4B-4C, by way of delimiting layer by layer the main three-dimensional inner circumferential surface 8461 overall, along the longitudinal axis line Y1, into multilayered annular grooves 847 located at the different layer levels (namely the longitudinal axis line Y1 serving as a datum-level line), the multilayered annular grooves 847 can be evenly and annularly arranged around an entire three-dimensional contour shape of the main three-dimensional inner circumferential surface 8461 along a three-dimensional direction thereof. Furthermore, the multilayered annular grooves 847 are layer-by-layer arranged along the longitudinal axis line Y1 and extended in a direction parallel but discommunicated with each other, and each two of the parallel annular grooves 847 are spaced with a fixed interval.

Preferably, as depicted in FIGS. 4B-4C, since the main three-dimensional inner circumferential surface 8461 is further divided into a number of widened sidewalls 8462 formed between the top side 841 and the back side 843, and a number of narrowed sidewalls 8466 facing away from the inner forming surface 845 of the cavity structure 840. Preferably, the narrowed sidewalls 8466 further comprises a narrowed bottom sidewall 8466′ located between a bottom portion of the inner forming surface 845 and the back side 843 to be in a direction transversally extended, and a number of laterally-narrowed sidewalls 8466″ longitudinally formed around the narrowed bottom sidewall 8466′. Accordingly, the multilayered annular grooves 847 are evenly and annularly arranged around the entire three-dimensional contour shapes of both the widened sidewalls 8462 and the narrowed sidewalls 8466 (comprising the narrowed bottom sidewall 8466′ and the laterally-narrowed sidewalls 8466″) along a three-dimensional (3D) direction thereof.

Besides, further referring to FIGS. 2 & 4A-4B with the same illustration as depicted in FIG. 3C, the heating device 86 can also be disposed within the female mould 84, and is principally constructed of: a number of heating tubes 862, a power source interface 864 configured to electrically connect the heating tubes 862 to the external power source (not shown), at least one temperature sensing member 863, a temperature regulation-and-control module 858, and a plurality of temperature controlling circuits 861, which operate independently of each other, each configured to independently regulate and control a heating temperature generated from corresponding one of the heating tubes 862. Further referring to FIGS. 2, 3C & 4B-4C, the heating tubes 862 and the power source interface 864 of the heating device 86 both are disposed within the female mould 84, to be in a manner that at the same time when the paired moulds 82, 84 are die-matched mutually for compression-forming the respective paper-made article, the heating device 86 also heats inside the female mould 84 (e.g., in the slurry-suctioning and thermal compression forming stage and/or thermal compression shaping stage of the pulp-molding production line) so as to further conduct heat (as indirectly heating) to the respective paper-made article, through the heated female mould 84 contacting with the respective paper-made article, thereby removing moistures and/or vapors contained within the respective paper-made article. For example, the at least one temperature sensing member 863 is detachably disposed inside corresponding one of the annular grooves 847 formed around the main three-dimensional inner circumferential surface 8461 of the female mould 84 (or is configured to replace a partial of the heating tubes 862 originally disposed inside the corresponding annular grooves 847), thereby detecting a local temperature from a local area of the female mould 84, to which the at least one temperature sensing member 863 is located adjacent, and then sending a temperature-sensing signal indicative of the local temperature to the temperature regulation-and-control module 858 for a temperature regulation-and-control implementation. The temperature controlling circuits 861 operating independently of each other are electrically connected to the temperature regulation-and-control module 858. By that way, the temperature regulation-and-control module 858 can implement a temperature regulation-and-control, through the individual temperature controlling circuit 861 operating independently of the other controlling circuits 861, for the corresponding one of the heating tubes 862. Briefly, it is capable of implementing individually a temperature regulation-and-control for an excessively heat-concentrating region or excessively heat-dissipating region within the female mould 84. Since being substantially the same as the above-mentioned heating device 86 in the first embodiment of the present invention, the other detailed structures and functions with relation to the heating device 86 of the female mould 84 shown in FIGS. 4A-4C can therefore refer to FIGS. 2 & 3C and will be omitted in the following descriptions.

In assembly as depicted in FIGS. 4B-4C, the heating tubes 862 are layer-by-layer arranged, in an evenly and annularly heating distribution along the longitudinal axis line Y1, into a multilayer-stacked structure with an annular shape in conformity with a scale of the entire three-dimensional contour shape of the main three-dimensional inner circumferential surface 8461 of the female mould 84. All the heating tubes 862 of the multilayer-stacked structure can be moved into/out from the main inner space of the main accommodating chamber 846 through the back side 843 of the female mould 84, in order to directly and detachably assemble the heating tubes 862 into the inside of the main inner space of the main accommodating chamber 846, in an evenly and annularly distribution inside the multilayered annular grooves 847 of the main three-dimensional inner circumferential surface 8461. Therefore, it is capable of accomplishing simply and rapidly modular assembling/disassembling of the heating tubes 862, to be in a way of random constitution and replacement on demands of different paper-made article shapes. Since the multilayered annular grooves 847 are kept in parallelly fixed intervals and discommunication with each other, the heating tubes 862 of the multilayer-stacked structure assembled into the annular shape are also kept in parallelly fixed intervals and discommunication with each other (namely without establishment of electrically and/or mechanically connection). After the heating tubes 862 are assembled, the heating tubes 862 do not only evenly heat and conduct heat against the entire three-dimensional contour shape of the main three-dimensional inner circumferential surface 8461, in a direction which the heating tubes 862 directly contact against the entire three-dimensional contour shape of the main three-dimensional inner circumferential surface 8461, but simultaneously the heating tubes 862 also evenly heat an air inside the main inner space of the main accommodating chamber 846, in another direction which the heating tubes 862 are also exposed to the main inner space of the main accommodating chamber 846.

By that ways of inwardly hollowing inside the back portion of the female mould 84 to form the main accommodating chamber 846, and making the heating tubes 862 being evenly heat-distributed around the three-dimensional contour shape of the main three-dimensional inner circumferential surface 8461 of the female mould 84 along a three-dimensional (3D) direction thereof, the three-dimensional contour shape, with different level regions, of the inner forming surface 845 of the female mould 84 has the same or the similar heat-conducting (or thermal diffusion) distances with relation to the heating tubes 862. Accordingly, while the female mould 84 thermally compresses the respective paper-made article during the slurry-suctioning and thermal compression forming stage and/or thermal compression shaping stage, it would make consistently heat-conducting velocities and evenly heating from the heating tubes 862 to the respective level regions of the entire three-dimensional contour shape of the inner forming surface 845 of the female mould 84, and thereby further expediting the female mould 84 providing consistent heated time and heated distances for each place of the entire three-dimensional contour dimensions, with corresponding to the heating tubes 862, of the respective paper-made article. Furthermore, the heat-conducting (or thermal diffusion) distances from the three-dimensional contour shape of the inner forming surface 845 to the heating tubes 862 all can be greatly reduced simultaneously, to serve as greatly reducing the heat-conducting (or thermal diffusion) distances from the entire three-dimensional contour dimensions of the respective paper-made article to the corresponding heating tubes 862. Therefore, it is capable of greatly reducing a heating time, raising a thermal diffusion efficiency, reducing a power consumption required for heating to dryness, and thereby accomplishing a low consumption objective, for the heating device 86; and simultaneously, it is further capable of reducing a drying cycle time for the respective paper-made article, and thereby reducing a total production cycle time of the pulp-molding production line, in order to accomplish a high-efficient yield of the paper-made articles.

Besides, further referring to the illustrations depicted in FIGS. 2 & 4A-4B, the vacuumizing device 88 is also air-communicated with a number of micro vents 882, formed through the female mould 84, via a number of conduits, thereby creating a vacuum environment inside the main inner space of the main accommodating chamber 846, to be in a way of expeditiously removing and exhausting moistures and/or vapors, contained within the respective paper-made article, through the female mould 84 (as disposed in the above-mentioned slurry-suctioning and thermal compression forming stage and/or thermal compression shaping stage).

Further referring to an illustration depicted in FIGS. 2 & 4A-4C, at the same time while the vacuumizing device 88 proceeds on vacuumizing the main inner space of the main accommodating chamber 846, the heating tubes 862 also evenly heat toward the main inner space of the main accommodating chamber 846 through the air inside the main inner space, to make the main accommodating chamber 846, which is air-tightly covered up by the covering plate 849, yielding a thermal preservation effect by way of a vacuum heat-insulation thereof. Therefore, it could insulate the heat from dissipation in case of overlong heat-conducting distances from the heating tubes 862 to the inner forming surface 845 of the female mould 84, thereby further raising the heating efficiency, reducing a power consumption required for heating to dryness, and thereby accomplishing a low consumption, for the heating device 86.

In more details as depicted in FIGS. 4B-4C, all the heating tubes 862 of the multilayer-stacked structure layer-by-layer surround and abut against the entire three-dimensional contour shapes of both the widened sidewalls 8462 and the narrowed sidewalls 8466 (comprising the narrowed bottom sidewall 8466′ and the laterally-narrowed sidewalls 8466″) of the main three-dimensional inner circumferential surface 8461, along a three-dimensional (3D) direction thereof, in order to accomplish an evenly and annularly heating distribution around the entire three-dimensional contour shapes. Preferably, since annularly inner perimeters of both the widened sidewalls 8462 and the narrowed sidewalls 8466 are different from each other, outermost annular perimeters of a partial of the heating tubes 862 layer-by-layer arranged in an evenly and annularly heating distribution arranged around the annularly inner perimeters of the widened sidewalls 8462 are different from (e.g., is larger than) outermost annular perimeters of another partial of the heating tubes 862 layer-by-layer arranged in an evenly and annularly heating distribution around the annularly inner perimeters of the narrowed sidewalls 8466. Preferably, each of the heating tubes 862 annularly arranged around both the widened sidewalls 8462 and the narrowed sidewalls 8466 all are rendered in a □-shaped structure. Preferably, the heating tubes 862 annularly arranged around the narrowed sidewalls 8466 all are kept in an interval distance of 2-5 cm from the inner forming surface 845 but not limited to this interval distance.

Further referring to FIGS. 4B-4C, since the annularly inner perimeters of both the narrowed bottom sidewall 8466′ and the laterally-narrowed sidewalls 8466″ of the narrowed sidewalls 8466 are different from each other in their structures and shapes, the outermost annular perimeters of the heating tubes 862 layer-by-layer arranged in an evenly and annularly heating distribution around the laterally-narrowed sidewalls 8466″ are different from (as being larger than) the outermost annular perimeters of the heating tubes 862 layer-by-layer arranged in an evenly and annularly heating distribution around the narrowed bottom sidewall 8466′. Preferably, each of the heating tubes 862 evenly and annularly arranged around the narrowed bottom sidewall 8466′ all are rendered in a U-shaped structure. In another embodiment, each of the heating tubes 862 evenly and annularly arranged around the narrowed bottom sidewall 8466′ can be rendered in a S-shaped structure.

Further referring to FIGS. 2 & 5A-5B, FIG. 5A depicts an element-exploded diagram of a male mould 82′ of a third preferred embodiment according to the present invention, and FIG. 5B depicts a laterally cross-sectional diagram in accordance with the male mould 82′ shown in FIG. 5A, which is assembled. As depicted in FIGS. 5A-5B, the male mould 82′ in the third preferred embodiment is similar and is capable of being applied to the pulp-molding mould assembly 70 having the heating device 86 as depicted in FIG. 2. It only needs to replace the male mould 82 in the first preferred embodiment as depicted in FIG. 2, with the male mould 82′ in the third preferred embodiment as depicted in FIGS. 5A-5B. It means that the other same members, such as the female mould 84, the heating device 86, and the vacuumizing device 88, all can refer to their structures and functions depicted in FIGS. 2 & 3C, and therefore will be omitted in the following descriptions.

Besides, in contrast with the male mould 82 of the first preferred embodiment depicted in FIGS. 3A-3B, the male mould 82′ of the third preferred embodiment depicted in FIGS. 5A-5B has the same structures in some portions thereof (e.g., the back portion of the male mould 82′ is also inwardly hollowed the inside thereof to form a main accommodating chamber 826 that is defined with a main inner space and a main three-dimensional inner circumferential surface 8261). However, the male mould 82′ also has different structures in other portions thereof. For example, the male mould 82′ of the third preferred embodiment further comprises a heat-conducting middle body 89 that is disposed inside the main inner space of the main accommodating chamber 826. The heat-conducting middle body 89, serving as a metallic heating plate for heat-conduction, has a secondary three-dimensional outer circumferential surface 8962 in conformity with a scale of an entire three-dimensional contour shape of the main three-dimensional inner circumferential surface 8261 of the male mould 82′, thereby implementing a thermal diffusion through directly contacting with the main three-dimensional inner circumferential surface 8261 of the male mould 82′. And, a secondary accommodating chamber 896 is also formed by inwardly hollowing inside a back portion of the heat-conducting middle body 89. The secondary accommodating chamber 896 is further defined with a secondary inner space and a secondary three-dimensional inner circumferential surface 8961 facing the secondary inner space but facing away from the secondary three-dimensional outer circumferential surface 8962, wherein the secondary three-dimensional outer circumferential surface 8962 overall is delimited layer by layer, along a longitudinal axis line Y1 (serving as a datum-level line), into multilayered annular grooves 897 located at different layer levels. As depicted in FIG. 2, the heating tubes 862 are evenly and annularly disposed layer-by-layer inside the multilayered annular grooves 897 of the secondary three-dimensional outer circumferential surface 8962, to make all the heating tubes 862 of the multilayer-stacked structure layer-by-layer surrounding and abutting against the entire three-dimensional contour shape of the secondary three-dimensional outer circumferential surface 8962. By that way, the heating tubes 862 do not only evenly heat an air inside the secondary inner space of the secondary accommodating chamber 896, in a direction which the heating tubes 862 are exposed to toward the secondary inner space of the secondary accommodating chamber 896, but simultaneously the heating tubes 862 also evenly heat and conduct heat against the entire three-dimensional contour shape of the secondary three-dimensional outer circumferential surface 8962, in another direction which the heating tubes 862 directly contact with the entire three-dimensional contour shape of the secondary three-dimensional outer circumferential surface 8962, in order to make indirectly and evenly thermal diffusion from the heating tubes 862 to the corresponding paper-made article through the male mould 82′.

Similarly, as depicted in FIGS. 5A-5B, the male mould 82′ is also air-communicated with the vacuumizing device 88 shown in FIG. 2, via a number of conduits. The vacuumizing device 88 as depicted in FIG. 2 is configured to vacuumize both the main inner space of the main accommodating chamber 826 of the male mould 82′ and the secondary inner space of the secondary accommodating chamber 896 of the heat-conducting middle body 89 to form vacuum environments therein, in a manner that when the heating tubes 862 evenly heat an air inside the secondary inner space of the secondary accommodating chamber 896. By way of a covering plate 829 of the male mould 82′ air-tightly covering up both the main accommodating chamber 826 and the secondary accommodating chamber 896, the main inner space of the main accommodating chamber 826 of the male mould 82′ and the secondary inner space of the secondary accommodating chamber 896 of the heat-conducting middle body 89, both of which are vacuumized, can yield a thermal preservation effect by way of a vacuum heat-insulation thereof.

In assembly as depicted in FIGS. 5A-5B, the heating tubes 862 can be directly detachably assembled, in an evenly and annularly arrangement, inside the multilayered annular grooves 897 around the secondary three-dimensional outer circumferential surface 8962 of the heat-conducting middle body 89, to make all the heating tubes 862 of the multilayer-stacked structure is layer-by-layer surrounding and abutting against the entire three-dimensional contour shape of the secondary three-dimensional outer circumferential surface 8962. In more detail, the heating tubes 862 are moved into/out, along with the heat-conducting middle body 89, from the main inner space of the main accommodating chamber 826 of the male mould 82′. After the heating tubes 862 are assembled inside the male mould 82′, the heating tubes 862 can be firmly sandwiched between both the secondary three-dimensional outer circumferential surface 8962 of the heat-conducting middle body 89 and the main three-dimensional inner circumferential surface 8261 of the male mould 82′, as well as directly contacting with both the secondary three-dimensional outer circumferential surface 8962 of the heat-conducting middle body 89 and the main three-dimensional inner circumferential surface 8261 of the male mould 82′, for evenly heating both of the surfaces 8962, 8261.

Further referring to an illustration depicted in FIGS. 2 & 6A-6C, FIG. 6A depicts a pictorial view of a male mould 82″ of a fourth preferred embodiment according to the present invention, FIG. 6B depicts an element-exploded diagram of the male mould 82″ shown in FIG. 6A, and FIG. 6C depicts a transversally cross-sectional diagram in accordance with a sectioning line D-D drawn on the male mould 82″ shown in FIG. 6A. The male mould 82″ in the fourth preferred embodiment depicted in FIGS. 6A-6C is similar and is capable of being applied to the pulp-molding mould assembly 70 having the heating device 86 as depicted in FIG. 2. It only needs to replace the male mould 82 of the first preferred embodiment as depicted in FIG. 2, with the male mould 82″ in the fourth preferred embodiment as depicted in FIGS. 6A-6C. It means that the other rest members used with the male mould 82″, such as the female mould, the heating device 86, the vacuumizing device 88, all can refer to their structures and functions of the female mould 84 shown in FIGS. 2, 3A-3C and 4C, and therefore will be omitted in the following descriptions.

In contrast with the male mould 82 of the first preferred embodiment as depicted in FIGS. 3A-3B, the male mould 82″ of the fourth preferred embodiment depicted in FIGS. 6A-6C has the same structures in part thereof. For example, the male mould 82″ similarly has a longitudinal axis line Y1, a top side 821 located perpendicularly to the longitudinal axis line Y1, a back side 823 located oppositely to the top side 821, and a three-dimensional contour molding structure formed on the top side 821 along the longitudinal axis line Y1. In this embodiment, the three-dimensional contour molding structure is realized as a protrudent structure 820 with an outer forming surface 825 for correspondingly shaping an inner formed circumferential surface of the respective paper-made article. On the contrary, the male mould 82″ of the fourth preferred embodiment depicted in FIGS. 6A-6C in part is also different from the male mould 82 of the first preferred embodiment depicted in FIGS. 3A-3B in their structures. For example, since a three-dimensional contour shape of the outer forming surface 825 of the protrudent structure 820 of the male mould 82″ of the fourth preferred embodiment depicted in FIGS. 6A-6C has smaller level differences, the male mould 82″ is suitable for use with the pulp-molding production line to integrally form another-type paper-made articles (as having a flat-type profile) having smaller level differences.

Besides, a number of heating tubes 862 and a number of power source interfaces 864 are disposed inside the male mould 82″ of the fourth preferred embodiment depicted in FIGS. 6A-6C. The power source interfaces 864 are configured to electrically connect the heating tubes 862 to an external power source. Both the heating tubes 862 and the power source interfaces 864 of the fourth preferred embodiment depicted in FIGS. 6A-6C are also different from the heating tubes 862 and the power source interface 864 disposed inside the male mould 82 of the first preferred embodiment depicted in FIGS. 3A-3B in both their structures and the heating distributions. A plurality of grooves 827 are formed, in an even distribution within a solid inside the male mould 82″ of the fourth preferred embodiment depicted in FIGS. 6A-6C, between from the outer forming surface 825 of the protrudent structure 820 to the back side 823, and are in parallel but discommunication with each other (see FIG. 6C). The heating tubes 862 can be detachably disposed respectively inside the grooves 827. Preferably, the heating tubes 862 all are kept in an interval distance of 2-5 cm from the outer forming surface 825 but not limited thereto. Preferably, the grooves 827 all are straight and outwardly extended through the outermost sidewall of the male mould 82″, to define a number of corresponding through bores 8272 on the outermost sidewall. Preferably, each of the heating tubes 862 is rendered in a straight rod-like structure, thereby making the heating tubes 862 being rapidly and straightly inserted into or drawn out the insides of the grooves 827 through the corresponding through bores 8272. Therefore, it is capable of accomplishing simply and rapidly modular assembling/disassembling of the heating tubes 862 for the male mould 82″, to be in a way of random constitution and replacement on demands of different paper-made article shapes. Simultaneously, since the three-dimensional contour shape of the outer forming surface 825 of the protrudent structure 820 of the male mould 82″ has different level regions formed thereon with smaller level differences, therefore the different level regions of the three-dimensional contour shape of the outer forming surface 825 of the male mould 82″ all have the same or the similar heat-conducting (or thermal diffusion) distances with relation to the corresponding heating tubes 862. This would make the heating tubes 862 providing consistently heat-conducting velocities and evenly heating for the three-dimensional contour shape of the outer forming surface 825 of the male mould 82″, thereby indirectly expediting the heating tubes 862 providing evenly and consistently heating time and heating distances, through the heated male mould 82″, for the entire three-dimensional contour dimensions of the respective paper-made article, at the same time while the heated male mould 82″ is employed to compression-form the entire three-dimensional contour dimensions of the respective paper-made article through the slurry-suctioning and thermal compression forming stage and/or thermal compression shaping stage.

Besides, a heating device suitable for use with the male mould 82″ of the fourth preferred embodiment depicted in FIGS. 6A-6C is similar to the heating device 86 depicted in FIGS. 2 & 3C. For example, a structure of the at least one temperature sensing member 863 depicted in FIG. 3C can also be replaced with a straight rod-like structure. Therefore, it is capable of being rapidly and straightly inserted into or drawn out from the grooves 827 of the male mould 82″ depicted in FIGS. 6A-6C (or being configured to replace a partial of the heating tubes 862 originally disposed inside the grooves 827), thereby detecting a local temperature from a local area of the male mould 82″, to which the at least one temperature sensing member 863 is located adjacent, and then sending a temperature-sensing signal indicative of the local temperature FIG. 3C depicted in the temperature regulation-and-control module 858 for further implementing a temperature regulation-and-control.

Besides, as depicted in FIG. 3C, the temperature controlling circuits 861 operating independently of each other are electrically connected to the temperature regulation-and-control module 858. By that way, the temperature regulation-and-control module 858 can implement a temperature regulation-and-control, through the individual temperature controlling circuit 861 operating independently of the other controlling circuits 861, for the corresponding one of the heating tubes 862 depicted in FIGS. 6A-6C. Briefly, it is capable of implementing individually a temperature regulation-and-control for an excessively heat-concentrating region or excessively heat-dissipating region within the male mould 82″. Since being substantially the same as the above-mentioned heating device 86 in the first embodiment of the present invention, the other detailed structures and functions with relation to the heating device 86 of the male mould 82″ shown in FIGS. 6A-6C can therefore refer to FIGS. 2 & 3C and will be omitted in the following descriptions.

Further referring to an illustration depicted in FIGS. 2 & 7A-7C, FIG. 7A depicts a pictorial view of a female mould 84″ of a fifth preferred embodiment according to the present invention, FIG. 7B depicts an element-exploded diagram of the female mould 84″ shown in FIG. 7A, and FIG. 7C depicts a laterally cross-sectional diagram in accordance with a sectioning line E-E drawn on the female mould 84″ shown in FIG. 7A. The female mould 84″ of the fifth preferred embodiment depicted in FIGS. 7A-7C is structurally and functionally similar to the above-mentioned female moulds and therefore capable of being applied to the pulp-molding mould assembly 70 having the heating device 86, as depicted in FIG. 2. It only needs to replace the female mould 84 of the second preferred embodiment depicted in FIGS. 2 & 4A-4B, with the female mould 84″ of the fifth preferred embodiment depicted in FIGS. 7A-7C. It means that mostly the other rest members used with the female mould 84″, such as the male mould 82 (or 82′, 82″), the heating device 86, the vacuumizing device 88 and vacuumizing device, all can refer to their structures and functions depicted in FIGS. 2, 3A-3C & 5A-6C, and therefore will be omitted in the following descriptions.

In contrast with the female mould 84 of the second preferred embodiment depicted in FIGS. 4A-4B, the female mould 84″ of the fifth preferred embodiment depicted in FIGS. 7A-7C has the same structure in part thereof. For example, similarly the female mould 84″ has a longitudinal axis line Y1, a top side 841 located perpendicularly to the longitudinal axis line Y1, a back side 843 located oppositely to the top side 841, and a three-dimensional contour molding structure formed on the top side 841 along the longitudinal axis line Y1. In this embodiment, the three-dimensional contour molding structure is realized as a cavity structure 840 with an inner forming surface 845 thereon for correspondingly shaping an outer formed circumferential surface of the respective paper-made article. On the contrary, the female mould 84″ of the fifth preferred embodiment depicted in FIGS. 7A-7C has partially different structures from the female mould 84 of the second preferred embodiment depicted in FIGS. 4A-4B. For example, a three-dimensional contour shape of the inner forming surface 845 of the cavity structure 840 of the female mould 84″ of the fifth preferred embodiment has smaller level difference, and therefore is suitable for use with the pulp-molding production line to integrally form another-type paper-made article (e.g., having a flat-type profile) having smaller level difference.

Besides, a number of heating tubes 862 and a number of power source interfaces 864 are disposed inside the female mould 84″ of the fifth preferred embodiment depicted in FIGS. 7A-7C. The power source interfaces 864 are configured to electrically connect the heating tubes 862 to an external power source. Both the heating tubes 862 and the power source interfaces 864 of the fifth preferred embodiment depicted in FIGS. 7A-7C are also different from the heating tubes 862 and the power source interface 864 disposed inside the female mould 84 of the second preferred embodiment depicted in FIGS. 4A-4B in both their structures and the heating distributions. A plurality of grooves 847 are formed, in an even distribution within a solid inside the female mould 84″ of the fifth preferred embodiment depicted in FIGS. 7A-7C, between from the inner forming surface 845 of the cavity structure 840 to the back side 843, and are in parallel but discommunication with each other (see FIG. 7C), thereby making the heating tubes 862 being detachably disposed respectively inside the grooves 847. Preferably, different layer levels located, inside the female mould 84″, relative to the longitudinal axis line Y1, make the inside of the female mould 84″ being delimited layer by layer, along the longitudinal axis line Y1, into the grooves 847. Preferably, the heating tubes 862 all are kept in an interval distance of 2-5 cm from the inner forming surface 845 but not limited thereto. Preferably, the grooves 847 all are straight and outwardly extended through an outermost sidewall of the female mould 84″, to define a number of corresponding through bores 8472 on the outermost sidewall. Preferably, each of the heating tubes 862 is rendered in a straight rod-like structure, thereby making the heating tubes 862 being rapidly and straightly inserted into or drawn out the insides of the grooves 847 through the corresponding through bores 8472. Therefore, it is capable of accomplishing simply and rapidly modular assembling/disassembling of the heating tubes 862 for the female mould 84″, to be in a way of random constitution and replacement on demands of different paper-made article shapes. Simultaneously, since the three-dimensional contour shape of the inner forming surface 845 of the cavity structure 840 of the female mould 84″ has different level regions formed thereon with smaller level differences, therefore the different level regions of the three-dimensional contour shape of the inner forming surface 845 of the cavity structure 840 of the female mould 84″ all have the same or the similar heat-conducting (or thermal diffusion) distances with relation to the corresponding heating tubes 862. This would make the heating tubes 862 providing consistently heat-conducting velocities and evenly heating for the three-dimensional contour shape of the inner forming surface 845 of the female mould 84″, thereby indirectly expediting the heating tubes 862 providing evenly and consistently heating time and heating distances, through the heated female mould 84″, for the entire three-dimensional contour dimensions of the respective paper-made article, at the same time while the heated female mould 84″ is employed to compression-form the entire three-dimensional contour dimensions of the respective paper-made article through the slurry-suctioning and thermal compression forming stage and/or thermal compression shaping stage.

Besides, a heating device suitable for use with the female mould 84″ of the fifth preferred embodiment depicted in FIGS. 7A-7C is similar to the heating device 86 depicted in FIGS. 2 & 3C. For example, a structure of the at least one temperature sensing member 863 depicted in FIG. 3C can also be replaced with a straight rod-like structure. Therefore, it is capable of being rapidly and straightly inserted into or drawn out from the grooves 847 of the female mould 84″ depicted in FIGS. 7A-7C (or being configured to replace a partial of the heating tubes 862 originally disposed inside the grooves 847), thereby detecting a local temperature from a local area of the female mould 84″, to which the at least one temperature sensing member 863 is located adjacent, and then sending a temperature-sensing signal indicative of the local temperature to the temperature regulation-and-control module 858, as depicted in FIG. 3C, for further implementing a temperature regulation-and-control. Besides, as depicted in FIG. 3C, the temperature controlling circuits 861 operating independently of each other are electrically connected to the temperature regulation-and-control module 858. By that way, the temperature regulation-and-control module 858 can implement a temperature regulation-and-control, through the individual temperature controlling circuit 861 operating independently of the other controlling circuits 861, for the corresponding one of the heating tubes 862 depicted in FIGS. 7A-7C. Briefly, it is capable of implementing individually a temperature regulation-and-control for an excessively heat-concentrating region or excessively heat-dissipating region within the female mould 84″. Since being substantially the same as the above-mentioned heating device 86 in the first embodiment of the present invention, the other detailed structures and functions with relation to the heating device 86 of the female mould 84″ shown in FIGS. 7A-7C all can therefore refer to FIGS. 2 & 3C and will be omitted in the following descriptions.

As illustrated in the respective above-mentioned embodiments of the present invention, it can be fully realized that: in comparison with the prior arts, the pulp-molding mould assembly 70 with the heating device 86, according to the present invention, is capable of bringing the following merits that: (1) a three-dimensional contour shape of a forming surface (e.g., an outer forming surface 825 or an inner forming surface 845) of at least one mould (e.g. the male mould 82, 82′, 82″ and/or the female mould 84, 84″, which corresponds to the heating tubes 862, all has the same or the similar heat-conducting (or thermal diffusion) distances, and consistently and evenly heat-conducting velocities, from the heating tubes 862 to the three-dimensional contour shape of the corresponding forming surface of the at least one mould during the slurry-suctioning and thermal compression forming stage and/or thermal compression shaping stage, thereby further achieving evenly or consistently heating time and heating distances from the heating tubes 862 to the entire three-dimensional contour dimensions of the respective paper-made article through the at least one mould. It would lead to greatly reduce heat-conducting (or thermal diffusion) distances from the heating tubes 862 to the entire three-dimensional contour dimensions of the respective paper-made article, thereby greatly reducing a heating time, raising a thermal-diffusion efficiency, reducing a power consumption required for heating to dryness, and thereby accomplishing a low consumption objective; (2) it is capable of reducing a drying cycle time for the respective paper-made article, thereby being further capable of reducing an overall production cycle time of the pulp-molding production line, to accomplish a high-efficient yield of the paper-made articles; (3) while an inside of the at least one mould (82, 82′, 82″, 84, and/or 84″) is heated for drying the respective paper-made article by the heating tubes 862, it is capable of accomplishing a thermal preservation effect by way of a vacuum heat-insulation thereof, to be in a way of reducing the heat dissipation in case of overlong heat-conducting distances from the heating tubes 862 to a corresponding forming surface of the at least one mould, thereby further raising a heating efficiency, reducing a power consumption required for heating to dryness, and thereby accomplishing a low consumption objective, for the heating device 86, wherein by way of inwardly hollowing inside a back portion of the at least one mould, the at least one mould can be weight-lost and thinned to reduce its mould cost, increase formed depths of the respective product, and reduce apparatus carrying capacity and transportation matters; (4) the heating tubes 862 that are layer-by-layer disposed in an evenly and annularly heating distribution around and against the inside of the at least one mould along a three-dimensional (3D) direction thereof, are electrically connected respectively with a number of temperature controlling circuits operating, independently from each other, to be in a way of individually implementing a temperature regulation-and-control for excessively heat-concentrating or heat dissipating regions of the at least one mould; and (5) the heating tubes 862 have a waterproof capability (e.g., in conformity with the international waterproof level of IP67), which is not only capable of isolating the vacuum from leakage, and facilitating directly clearing and maintenance on the at least one mould, but also accomplishing simply and rapidly modular assembling/disassembling of the heating tubes 862, in a way of random constitution and replacement on demands of different paper-made article shapes.

In conclusion, although the present invention is described with the respective preferred embodiments as described above, those skilled in the art will appreciate that various modifications, additions, and substitutions are possible without departing from the scope and the spirit of the invention. Accordingly, the scope of the present invention is intended to be defined only by reference to the claims.

What is claimed is:

1. A pulp-molding mould assembly with a heating device, which is deployed within a pulp-molding production line to integrally form a plurality of paper-made articles each having three-dimensional contour dimensions, comprising:
two paired moulds, operating on die-matching mutually to integrally form the three-dimensional contour dimensions of the respective paper-made article, wherein at least one of the paired moulds has a longitudinal axis line, a top side located perpendicularly to the longitudinal axis line, a back side located oppositely to the top side, and a three-dimensional contour molding structure, which is formed on the top side along the longitudinal axis line, having a forming surface configured on correspondingly shaping a formed circumferential surface of the respective paper-made article; and
the heating device, disposed inside the at least one mould, to heat the at least one mould, thereby indirectly heating the respective paper-made article through the at least one mould, and the heating device comprising a number of heating tubes, and a power source interface configured to electrically connect the heating tubes with an external power source; and wherein
a main accommodating chamber is formed by way of hollowing inside the at least one mould, between from the forming surface of the three-dimensional contour molding structure to the back side, in a way to define a main inner space and a main three-dimensional inner circumferential surface facing the main inner space, and the heating tubes are layer-by-layer arranged in an evenly and annularly heating distribution to constitute a multilayer-stacked structure with an annular shape in conformity with a scale of a three-dimensional contour shape of the entire main three-dimensional inner circumferential surface, and the multilayer-stacked structure is detachably assembled within the main inner space of the main accommodating chamber, to make the heating tubes heating and conducting heat against the three-dimensional contour shape of the entire main three-dimensional inner circumferential surface.

2. The pulp-molding mould assembly with the heating device according to claim 1, wherein the main three-dimensional inner circumferential surface is further divided into a number of narrowed sidewalls facing away from the forming surface of the three-dimensional contour molding structure, and a number of widened sidewalls formed between the forming surface and the back side, wherein a partial of the heating tubes of the multilayer-stacked structure are layer-by-layer arranged in an evenly and annularly heating distribution around the narrowed sidewalls and all are kept in an interval distance of 2-5 cm from the forming surface.

3. The pulp-molding mould assembly with the heating device according to claim 1, wherein along the longitudinal axis line, the entire main three-dimensional inner circumferential surface is delimited layer by layer into multilayered annular grooves located at different layer levels, and the heating tubes are disposed respectively inside the multilayered annular grooves of the main three-dimensional inner circumferential surface, to make the heating tubes of the multilayer-stacked structure layer-by-layer surrounding and abutting against the three-dimensional contour shape of the entire main three-dimensional inner circumferential surface, to be in a manner that the heating tubes heat an air, inside the main inner space of the main accommodating chamber, toward a direction which the heating tubes are exposed to the main inner space of the main accommodating chamber, as well as evenly heating and conducting heat against the three-dimensional contour shape of the entire main three-dimensional inner circumferential surface, toward another direction which the heating tubes directly contact against the three-dimensional contour shape of the entire main three-dimensional inner circumferential surface.

4. The pulp-molding mould assembly with the heating device according to claim 3, wherein the at least one mould further has a covering plate which is detachably retained on the back side to air-tightly cover up the main accommodating chamber, and the at least one mould is further air-communicated with a vacuumizing device to create a vacuum environment inside the main inner space of the main accommodating chamber, to be in a manner that when the heating tubes heat the air toward the direction to the main inner space of the main accommodating chamber, a vacuum heat-insulation occurs inside the main accommodating chamber, which is air-tightly covered up by the covering plate, to yield a thermal preservation effect inside the main accommodating chamber.

5. The pulp-molding mould assembly with the heating device according to claim 3, wherein the heating tubes are capable of being moved into/out from the main inner space of the main accommodating chamber, to be directly assembled detachably inside the multilayered annular grooves of the main three-dimensional inner circumferential surface, and to expose the heating tubes, toward the main inner space of the main accommodating chamber, in a manner of evenly heating the air.

6. The pulp-molding mould assembly with the heating device according to claim 1, wherein the at least one mould further comprises a heat-conducting middle body disposed inside the main inner space of the main accommodating chamber and having a secondary three-dimensional outer circumferential surface, in conformity to the scale of the three-dimensional contour shape of the entire main three-dimensional inner circumferential surface, under a manner of directly contacting with the main three-dimensional inner circumferential surface, and a back portion of the heat-conducting middle body is inwardly hollowed to form a secondary accommodating chamber which defines a secondary inner space and a secondary three-dimensional inner circumferential surface facing the secondary inner space but facing away from the secondary three-dimensional outer circumferential surface, wherein along the longitudinal axis line, the entire secondary three-dimensional outer circumferential surface is delimited layer by layer into multilayered annular grooves located at different layer levels, and the heating tubes are respectively disposed inside the multilayered annular grooves of the secondary three-dimensional outer circumferential surface, to make the heating tubes of the multilayer-stacked structure layer-by-layer surrounding and abutting against a three-dimensional contour shape of the entire secondary three-dimensional outer circumferential surface, to be in a manner that the heating tubes all evenly heat the air toward a direction to the secondary inner space of the secondary accommodating chamber, as well as evenly heating and conducting heat, toward another direction to directly contact against the three-dimensional contour shape of the entire secondary three-dimensional outer circumferential surface, to make indirectly and evenly thermal diffusion onto the main three-dimensional inner circumferential surface.

7. The pulp-molding mould assembly with the heating device according to claim 6, wherein the at least one mould is further air-communicated with a vacuumizing device to create a vacuum environment inside both the main inner space of the main accommodating chamber and the secondary inner space of the secondary accommodating chamber, and the at least one mould further has a covering plate to be in a manner that when the heating tubes evenly heat the air toward the direction to the secondary inner space of the secondary accommodating chamber, a vacuum heat-insulation occurs inside both the main accommodating chamber and the secondary accommodating chamber, which are air-tightly covered up by the covering plate, to yield a thermal preservation effect inside both the main accommodating chamber and the secondary accommodating chamber.

8. The pulp-molding mould assembly with the heating device according to claim 6, wherein the heating tubes are capable of being moved into/out from the main inner space of the main accommodating chamber, to be directly assembled detachably between both of the multilayered annular grooves of the secondary three-dimensional outer circumferential surface and the main three-dimensional inner circumferential surface, for evenly heating.

9. The pulp-molding mould assembly with the heating device according to claim 1, wherein the main three-dimensional inner circumferential surface is formed to be one of a conical inner circumferential surface, a cambered inner circumferential surface, a cuboidal inner circumferential surface, a cubical inner circumferential surface, a cylindrical inner circumferential surface, a concave inner circumferential surface, a convex inner circumferential surface, and other geometric-shape inner circumferential surface.

10. The pulp-molding mould assembly with the heating device according to claim 1, wherein at least one of the heating tubes is extended in an outermost annular perimeter different from an outermost annular perimeter in which another one of the heating tubes is extended.

11. The pulp-molding mould assembly with the heating device according to claim 1, wherein the heating device further comprises at least one temperature sensing member and a temperature regulation-and-control module, the at least one temperature sensing member is capable of being selectively disposed within the at least one mould, to detect a local temperature from a local area of the at least one mould, which the at least one temperature sensing member is located adjacent to, and then to send a temperature-sensing signal indicative of the local temperature to the temperature regulation-and-control module, whereby the temperature regulation-and-control module, in accordance with the temperature-sensing signal, regulates and controls a power intensity output from the external power source, thereby further regulating and controlling, through the power source interface, a heating temperature of the respective heating tube located adjacent to the at least one temperature sensing member.

12. The pulp-molding mould assembly with the heating device according to claim 11, wherein the heating device comprises a plurality of temperature controlling circuits each operating, independently of the other temperature controlling circuits, in a manner of independently regulating and controlling the heating temperature of corresponding one of the heating tubes.

13. The pulp-molding mould assembly with the heating device according to claim 1, wherein the at least one mould is a male mould, and the three-dimensional contour molding structure is a protrudent structure, which is outwardly protruded from the top side along the longitudinal axis line, having an outer forming surface thereon for shaping an inner formed circumferential surface of the respectively paper-made article, wherein the main accommodating chamber is formed, between from the outer forming surface of the protrudent structure to the back side, by way of hollowing inside the male mould.

14. The pulp-molding mould assembly with the heating device according to claim 1, wherein the at least one mould is a female mould, and the three-dimensional contour molding structure is a cavity structure, which is inwardly caved from the top side along the longitudinal axis line, having an inner forming surface thereon for shaping an outer formed circumferential surface of the respective paper-made article, wherein the main accommodating chamber is formed, between from the inner forming surface of the cavity structure to the back side, by way of hollowing inside the female mould.

15. A pulp-molding mould assembly with a heating device, which is deployed within a pulp-molding production line to integrally form a plurality of paper-made articles each having three-dimensional contour dimensions, comprising:
two paired moulds, operating on die-matching mutually to integrally form the three-dimensional contour dimensions of the respective paper-made article, wherein at least one of the paired moulds has a longitudinal axis line, a top side located perpendicularly to the longitudinal axis line, a back side located oppositely to the top side, and a three-dimensional contour molding structure, which is formed on the top side along the longitudinal axis line, having a forming surface configured on correspondingly shaping a formed circumferential surface of the respective paper-made article; and
the heating device, disposed inside the at least one mould, to heat the at least one mould, thereby indirectly heating the respective paper-made article through the at least one mould, and the heating device comprising a number of heating tubes, and a number of power source interfaces configured to electrically connect the heating tubes respectively with an external power source; and wherein
a plurality of grooves are formed, between from the forming surface of the three-dimensional contour molding structure to the back side, in an even distribution inside the at least one mould, and are in parallel but discommunication with each other, to be in a way of making the heating tubes being detachably disposed, one-to-one, inside the grooves, and the heating device further comprises a plurality of temperature controlling circuits each operating, independently of the other temperature controlling circuits, in a manner of independently regulating and controlling a heating temperature of corresponding one of the heating tubes.

16. The pulp-molding mould assembly with the heating device according to claim 15, wherein by a number of different layer levels where the grooves are respectively located inside the at least one mould, an inside of the at least one mould is delimited layer by layer into the grooves along the longitudinal axis line.

17. The pulp-molding mould assembly with the heating device according to claim 15, wherein the heating device further comprises at least one temperature sensing member and a temperature regulation-and-control module, the at least one temperature sensing member is detachably arranged within at least one of the grooves, and operates to detect a local temperature from a local area of the at least one mould, which the at least one temperature sensing member is located adjacent to, and then to send a temperature-sensing signal indicative of the local temperature to the temperature regulation-and-control module, whereby the temperature regulation-and-control module, in accordance with the temperature-sensing signal, regulates and controls a power intensity output from the external power source, thereby further regulating and controlling, through the power source interface, a heating temperature of the respective heating tube located adjacent to the at least one temperature sensing member, and the temperature regulation-and-control module further comprises the temperature controlling circuits operating independently of each other.

18. The pulp-molding mould assembly with the heating device according to claim 15, wherein the respective heating tube is rendered in a straight rod-like structure.

19. The pulp-molding mould assembly with the heating device according to claim 15, wherein the heating tubes all are kept in an interval distance of 2-5 cm from the forming surface.

20. The pulp-molding mould assembly with the heating device according to claim 15, wherein the grooves all are straightly extended through an outermost sidewall of the at least one mould, to form a number of corresponding through bores on the outermost sidewall, such that the heating tubes are directly and straightly inserted into or drawn out the grooves through the corresponding through bores, respectively.
